(19) United States
(12) Patent Application Publication
(10) Pub. No.: US 2010/0332108 A1
(43) Pub. Date: Dec. 30, 2010

(54) FUEL VAPOR PRESSURE MEASURING DEVICE

(75) Inventors: Yoshinobu Kato, Ichinomiya-shi (JP); Masaki Ikeya, Obu-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-shi, Aichi (JP)

(21) Appl. No.: 12/865,928

(22) PCT Filed: Feb. 24, 2009
(86) PCT No.: PCT/JP2009/053251

§ 371 Date: Aug. 3, 2010

(30) Foreign Application Priority Data
Feb. 25, 2008 (JP) 2008-043104
Feb. 25, 2008 (JP) 2008-043191
Feb. 26, 2008 (JP) 2008-044149

(51) Int. Cl. F02P 5/15; F02M 51/00; G01M 15/00

(52) U.S. Cl. 701/104; 701/105; 73/114.43

(57) ABSTRACT

A fuel vapor pressure measuring device is provided, in a fuel supplying system, with a fuel tank for containing fuel, a fuel pump for supplying the fuel in the fuel tank to an injector, a fuel vapor generating section having a nozzle, a vaporizing chamber, and a venturi and vaporizing, in the vaporizing chamber, fuel by ejecting the fuel from the nozzle and causing the fuel to pass through the venturi, a first fuel path for interconnecting the fuel pump and the injector, a second fuel path having one end connected to the fuel pump and the other end connected to the fuel vapor generating section, a pressure sensor for detecting the pressure in the fuel vapor generating section, and an ECU for calculating the pressure of fuel vapor based on the result of detection by the pressure sensor. The fuel vapor generating section is mounted in the fuel tank.

### CROSS-REFERENCE TO RELATED APPLICATIONS

This is a national phase application filed under 35 U.S.C. 371 of PCT/JP2009/053251 filed on Feb. 24, 2009, which claims the benefit of priority from the prior Japanese Patent Applications No. 2008-043104 filed on Feb. 25, 2008, No. 2008-043191 filed on Feb. 25, 2008, and No. 2008-044149 filed on Feb. 26, 2008, the entire contents of all of which are incorporated herein by reference.

### TECHNICAL FIELD

The present invention relates to a vapor pressure measuring device for measuring fuel vapor pressure and more particularly to a vapor pressure measuring device for measuring vapor pressure of fuel to be supplied to an internal combustion engine.

### BACKGROUND ART

Currently, gasoline is mainly used as fuel for internal combustion engines. However, the properties of commercially available fuel (gasoline) are not always constant. Accordingly, the fuel vapor pressure varies from fuel to fuel. In particular, the fuel properties are often different according to destination places, leading to variations in fuel vapor pressure. Such variations in fuel vapor pressure may affect combustibility of the fuel. Thus, in current circumstances, internal combustion engines are adapted to each destination place.

However, the fuel vapor pressure tends to change according to oxidation of fuel, vaporization of fuel, and others. Even if the internal combustion engines are adapted to each destination place, therefore, it is difficult to optimally control a fuel injection amount, an injection timing, an ignition timing, etc. in all of the internal combustion engines. If the fuel injection amount, the injection timing, the ignition timing, and others are not optimally controlled due to the variation in fuel vapor pressure, startability during a cold period, emission performance, and driveability of the internal combustion engine are apt to deteriorate.

In all internal combustion engines, as above, it is necessary to measure fuel vapor pressure (fuel properties) to control the fuel injection amount, the injection timing, the ignition timing, and others. For example, a device for measuring such fuel properties is disclosed in Patent Literature 1. The device disclosed herein includes a water jet pump constituted of a chamber and a nozzle for injecting a fluid to be measured (“to-be-measured fluid”), a pressure sensor for measuring pressure of the chamber, a fuel temperature sensor for detecting fuel temperature in the chamber, and a property calculator for calculating properties of the to-be-measured fluid by receiving information from the pressure sensor and the fuel temperature sensor. This device is configured to inject the to-be-measured fluid from the nozzle to generate negative pressure in the chamber and then measure the pressure when the fuel is vaporized, thereby measuring a typical vapor pressure of the fuel, that is, the fuel property.

### CITATION LIST

### Patent Literature

Patent Literature 1: JP 5 (1993)-223723A

### SUMMARY OF INVENTION

### Technical Problem

However, the aforementioned liquid property measuring device would have a problem with difficulty in accurately calculating the vapor pressure. This is because the vapor pressure is a function of temperature and therefore an exact fuel temperature has to be detected, but the fuel temperature may not be detected accurately. Specifically, in the above liquid property measuring device, the water jet pump is placed outside a tank and thus the chamber is exposed to outside air. In this state, the chamber receives heat and releases heat under the influence of the outside air. The chamber temperature becomes uneven if the outside air temperature of the surrounding is not uniform. For instance, if an exhaust pipe or the like is present near the chamber, an error or deviation is likely to occur between the fuel temperature sensor and the fuel temperature. Furthermore, it is sufficiently conceivable that a difference in a coefficient of heat transfer between the chamber material and the vaporized fuel is a factor of the fuel temperature error.

The above liquid property measuring device could not calculate the vapor pressure with high accuracy. This is because sufficient negative pressure is not generated in the chamber during measurement of the internal pressure of the chamber, so that the fuel could not be sufficiently vaporized. Specifically, the reason why sufficient negative pressure is not generated in the chamber is as follows. Since the nozzle is placed to extend downward, the fuel is allowed to be discharged by gravity while no fuel is supplied. When the fuel is supplied subsequently, the to-be-measured fluid ejected from the nozzle hardly sticks to the wall surface of an outlet pipe (a venturi). Accordingly, the to-be-measured fluid could not block off between the chamber and the outlet pipe. As a result, the chamber becomes almost equal to the outside air pressure and sufficient negative pressure is not generated.

Even if the to-be-measured fluid injected from the nozzle sticks to the wall surface of the outlet pipe (the venturi), there is a problem that it takes long to stick to the wall surface, thereby causing a delay in generating negative pressure in the chamber, leading to poor measurement responsivity.

Furthermore, the above liquid property measuring device have problems with deterioration of each sensor (detection means) and an increase in electric power consumption. Such problems are caused because the above liquid property measuring device measures the vapor pressure by constantly detecting the internal pressure and the fuel temperature in the chamber. Deterioration of each sensor (detection means) results in lower measurement accuracy of the fuel vapor pressure. Much power consumption causes a decrease in fuel efficiency of the internal combustion engine.

The present invention has been made in view of the circumstances to solve the above problems and has a purpose to provide a fuel vapor pressure measuring device capable of accurately calculating vapor pressure without being affected by external influences. Another purpose of the invention is to provide a vapor pressure measuring device capable of accurately calculating vapor pressure by instantly generating sufficient negative pressure in a vaporizing chamber without loss of responsivity. Furthermore, another purpose of the invention is to provide a vapor pressure measuring device capable of preventing deterioration of detection means and reducing electric power consumption.

### Solution to Problem

To achieve the above purposes, the invention provides a fuel vapor pressure measuring device comprising: a fuel tank for storing fuel; a fuel pump for supplying the fuel in the fuel tank to a fuel injection device; a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber; a first fuel path that connects the fuel pump and the fuel injection device; a second fuel path having one end connected to the fuel pump or the first fuel path and the other end connected to the fuel vapor generating section; pressure detection means for detecting pressure of the fuel vapor generating section; and vapor pressure calculation means for calculating fuel vapor pressure based on a detection result of the pressure detection means, the fuel vapor generating section being placed in the fuel tank.

In this fuel vapor pressure measuring device, the first fuel path for supplying fuel from the fuel pump to the fuel injection device and the second fuel path for supplying fuel from the fuel pump (there are a case of direct supply from the pump and a case of supply via the first fuel path) to the fuel vapor generating section placed in the fuel tank. Accordingly, the fuel is supplied from the fuel pump to the second fuel path. The fuel flowing in the second fuel path reaches the nozzle. Herein, the nozzle has a diaphragm and thus the fuel emitted from the nozzle is supplied at an increased flow velocity to the vaporizing chamber, passes through the venturi, and then returns to the fuel tank. At that time, when the fuel injected from the nozzle passes through the throat part of the venturi, it generates negative pressure in the vaporizing chamber. This is because when the fuel passes through the throat part of the venturi, the fuel in the vaporizing chamber is pulled due to the influence of viscosity, thus generating the negative pressure in the vaporizing chamber.

This negative pressure generating action causes the fuel to vaporize under the reduced pressure, thereby generating the vapor pressure in the vaporizing chamber. The pressure of the vaporizing chamber comes into an equilibrium state based on the fuel vapor pressure. At that time, the internal pressure of the vaporizing chamber in the equilibrium state is detected by the pressure detection means. Then, the vapor pressure calculation means calculates the fuel vapor pressure based on a detection result of the pressure detection means. The vapor pressure calculated by the vapor pressure calculation means includes Reid vapor pressure. As above, the fuel vapor pressure can be calculated because the pressure of the vaporizing chamber changes according to a difference in vapor pressure (fuel property).

According to the above vapor pressure measuring device, as mentioned above, the fuel injected at an increased flow velocity by the diaphragm of the nozzle is vaporized under reduced pressure by the negative pressure generated in the vaporizing chamber. The internal pressure of the vaporizing chamber in the equilibrium state caused by the generated vapor pressure is detected by the pressure detection means and, based on the detection value, the fuel vapor pressure can be calculated by the vapor pressure calculation means. Since the fuel vapor generating section is placed in the fuel tank, the fuel is less influenced by outside air temperature. Accordingly, the fuel vapor pressure can be measured accurately.

Furthermore, since the fuel vapor generating section is placed in the fuel tank, even if some amount of fuel leaks from the fuel vapor generating section, it causes no problem. Consequently, the structure of the fuel vapor generating section, in particular, the sealing structure can be simplified.

By use of the measured vapor pressure, the fuel injection amount may be corrected to bring the internal combustion engine into an optimum operating state. Thus, the fuel injection amount can be corrected to an optimum value required by the internal combustion engine according to fuel types and temperatures. Consequently, a stable combustion state is constantly achieved. In particular, HC reduction, startability, and driveability during non-operating time of an AIF sensor during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

Preferably, the fuel vapor pressure measuring device according to the invention further comprises pressure regulation means is placed in the first fuel path, the second fuel path, or the fuel pump and configured to regulate a pressure of fuel allowed to flow in the fuel vapor generating section at a constant pressure.

Such pressure control means can make the fuel injection condition from the nozzle constant, thereby enabling vaporization of fuel under the same condition. This makes it possible to accurately detect the internal pressure of the vaporizing chamber and hence measure the fuel vapor pressure with higher accuracy.

Preferably, the fuel vapor pressure measuring device according to the invention further comprises: fuel temperature detection means for detecting a temperature of fuel allowed to pass through the fuel vapor generating section, wherein the vapor pressure calculation means is configured to correct the fuel vapor pressure calculated based on the detection result of the pressure detection means so that the fuel vapor pressure is corrected based on a detection result of the fuel temperature detection means.

The vapor pressure is a function of temperature. It is thus impossible to exactly measure (calculate) the vapor pressure if the fuel temperature is not stable. The fuel temperature detection means is therefore provided to detect the temperature of the fuel (in a liquid state) before vaporized in the fuel vapor generating section. Accordingly, the fuel temperature can be detected accurately as compared with the case of detecting the temperature of vaporized fuel. The fuel temperature exactly detected by the vapor pressure calculation means is used to correct the fuel vapor pressure calculated based on the detection result of the pressure detection means. Thus, the vapor pressure can be measured (calculated) with excellent accuracy.

Preferably, the fuel vapor pressure measuring device according to the invention further comprises: a control valve placed upstream of an inlet port of the vaporizing chamber or downstream of an outlet port of the vaporizing chamber, the control valve being configured to control inflow of the fuel to the vaporizing chamber.

Such control valve enables injection of fuel from the nozzle only during measurement of the fuel vapor pressure, thereby reliably generating negative pressure in the vaporizing chamber. This makes it possible to measure the fuel vapor pressure when the fuel injection amount is low and accurately measure the fuel vapor pressure without increasing the flow rate of the fuel pump.

In the fuel vapor pressure measuring device according to the invention, preferably, the fuel vapor generating section is housed together with the fuel pump in a sub-tank of the fuel tank.

Since the fuel vapor generating section is housed in the sub-tank of the fuel tank, the vapor pressure measuring device can be combined with a fuel pump and others into a module. As a result, installation of the vapor pressure measuring device can be facilitated and also mounting members can be simplified.

In the fuel vapor pressure measuring device according to the invention, preferably, the fuel pump is placed in the sub-tank to return the fuel that flows out of the fuel vapor generating section to the sub-tank.

Since the fuel flowing from the fuel vapor generating section is returned to the sub-tank, the fuel pump placed in the sub-tank can reliably pump up and supply the fuel even if the fuel pump is tilted.

In the fuel vapor pressure measuring device according to the invention, preferably, the fuel temperature detection means is placed upstream of and near the nozzle.

Since the fuel temperature detection means is placed in such a position, the temperature of liquid fuel near the nozzle can be detected. Accordingly, the temperature of fuel to be injected from the nozzle can be exactly measured. The measurement accuracy of the fuel vapor pressure can therefore be enhanced.

In the fuel vapor pressure measuring device according to the invention, preferably, the fuel temperature detection means is integrally attached to the fuel vapor generating section.

Since the fuel temperature detection means is integrally attached to the fuel vapor generating section, components of the vapor pressure measuring device can be concentrated. This can facilitate installation of the vapor pressure measuring device and simplify the mounting members.

In the fuel vapor pressure measuring device according to the invention, preferably, the fuel pump is attached to a fuel supply device including a sub-tank, and the fuel temperature detection means is placed near a bottom of the sub-tank.

At the bottom of the sub-tank, fuel stably exists and also the temperature of the fuel is stable. Accordingly, when the fuel temperature detection means is placed near the bottom of the sub-tank, the fuel temperature can be exactly detected without variations. The measurement accuracy of fuel vapor pressure can therefore be enhanced.

In the fuel vapor pressure measuring device according to the invention, preferably, the pressure detection means is placed outside of the fuel tank.

Since the pressure detection means is placed outside of the fuel tank as above, wiring to the pressure detection means can be facilitated and mounting easiness of the vapor pressure measuring device can be improved.

In the fuel vapor pressure measuring device according to the invention, preferably, the fuel vapor generating section is placed near a cover member of the fuel tank, and the pressure detection means is placed on the cover member outside of the fuel tank.

With the above configuration, the pressure detection means can be easily fixed and also the fuel vaporizing chamber, the pressure detection means themselves, connectors and others can be concentrated in the vicinity of the cover member. This can achieve a compact device.

Since the fuel vapor generating section is integrally formed with the cover member, the fuel vapor generating section as well as the pressure detection means itself and the connectors can be concentrated on the cover member. This can achieve a more compact device and further improve the mounting easiness of the vapor pressure measuring device with respect to the fuel tank.

In the fuel vapor pressure measuring device according to the invention, preferably, the pressure detection means and the fuel vapor generating section are connected to each other through a pressure sensitive wall.

In the above configuration, a pressure sensitive wall (e.g., a diaphragm) prevents entrance of fuel in the pressure detection section. This can prevent circuit troubles in the pressure detection section.

To solve the above problems, the invention provides a fuel vapor pressure measuring device comprising: a fuel tank for storing fuel; a fuel pump for supplying the fuel in the fuel tank to a fuel injection device; a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber; a first fuel path that connects the fuel pump and the fuel injection device; a second fuel path having one end connected to the fuel pump or the first fuel path and the other end connected to the fuel vapor generating section; pressure detection means for detecting pressure of the fuel vapor generating section; and vapor pressure calculation means for calculating fuel vapor pressure based on a detection result of the pressure detection means, the fuel vapor generating section is configured to allow fuel injected in the venturi to be collected in the venturi.

The above fuel vapor pressure measuring device includes the first fuel path for supplying fuel from the fuel pump to the fuel injection device and the second fuel path for supplying fuel from the fuel pump or the first fuel path to the fuel vapor generating section. Accordingly, the fuel is supplied from the fuel pump or the first fuel path to the second fuel path. The fuel flowing in the second fuel path reaches the nozzle. Herein, since the nozzle has a diaphragm, the fuel injected from the nozzle is supplied at an increased flow velocity to the vaporizing chamber, passes through the venturi, and then returns to the fuel tank. At that time, when passes through the venturi, the fuel injected from the nozzle generates sufficient negative pressure in the vaporizing chamber. This is because the vapor generating section is configured to allow the fuel injected in the venturi to be collected in the venturi and therefore the fuel collected in the venturi becomes resistance whereby the fuel injected from the nozzle sticks to the wall surface at the inlet port of the venturi, thereby shielding the vaporizing chamber from the outside. When the fuel in this state passes through the venturi, the fuel in the vaporizing chamber is pulled by the influence of viscosity. As soon as the fuel is injected from the nozzle, accordingly, sufficient negative pressure is generated in the vaporizing chamber.

This negative pressure generating action causes the fuel to vaporize under the reduced pressure, thereby generating the vapor pressure in the vaporizing chamber. The pressure of the vaporizing chamber comes to the equilibrium state based on the fuel vapor pressure. At that time, the internal pressure of the vaporizing chamber in the equilibrium state is detected by the pressure detection means. Thereafter, the fuel vapor pressure is calculated by the vapor pressure calculation means based on the detection result of the pressure detection means. It is to be noted that the vapor pressure calculated by the vapor pressure calculation means includes Reid vapor pressure. The reason why the fuel vapor pressure can be calculated as above is that the pressure of the vaporizing chamber changes according to a difference in vapor pressure (fuel property).

According to the above vapor pressure measuring device, the fuel vapor generating section is configured to allow the fuel injected in the venturi to be collected in the venturi. The fuel injected from the nozzle at an increased flow velocity can instantly generate sufficient negative pressure in the vaporizing chamber. As a result, the fuel is vaporized under the reduced pressure in the vaporizing chamber. The internal pressure of the vaporizing chamber in the equilibrium state caused by the generated vapor pressure is detected by the pressure detection means and, based on the detection value, the fuel vapor pressure can be calculated by the vapor pressure calculation means. Consequently, the fuel vapor pressure can be measured accurately without loss of responsivity.

By use of the measured vapor pressure, the fuel injection amount may be corrected to bring the internal combustion engine into an optimum operating state. Thus, the fuel injection amount can be corrected to an optimum value required by the internal combustion engine according to fuel types and temperatures. Consequently, a stable combustion state is constantly achieved. In particular, HC reduction, startability, and driveability during non-operating time of an AIF sensor (during open control) a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

In the fuel vapor pressure measuring device according to the invention, preferably, the fuel vapor generating section is configured such that an inlet port of the venturi is positioned below an outlet port of the venturi in a gravity direction.

Since the inlet port of the venturi is located below the outlet port in the gravity direction, the fuel is allowed to be collected by gravity in the venturi and the vaporizing chamber. As a result, as soon as the fuel is injected from the nozzle, the fuel sticks to the wall surface of the inlet port of the venturi, thereby shielding the vaporizing chamber from the outside. This can generate sufficient negative pressure in the vaporizing chamber. Such configuration can be easily achieved by simply changing a mounting angle of the fuel vapor generating section.

In the fuel vapor pressure measuring device according to the invention, preferably, the fuel vapor generating section includes a reflection plate for returning the fuel that flows out of the venturi to the venturi, the reflection plate being located near the outlet port of the venturi.

The above configuration allows the fuel to collide with the reflection plate and return to the venturi, thus allowing the fuel to be reliably collected in the venturi.

In the fuel vapor pressure measuring device according to the invention, preferably, a volume of the venturi is larger than a volume of the vaporizing chamber.

Herein, the vaporizing chamber is always in a negative pressure state while the fuel is being injected from the nozzle. When the injection is stopped, the vaporizing chamber attempts to return to atmospheric pressure, thereby the fuel on the venturi side is returned to the vaporizing chamber side. At that time, in case the space volume in the venturi is smaller than the space volume in the vaporizing chamber, the fuel disappears from the inlet port of the venturi, thereby leading to a delay for the fuel to stick to the inlet port of the venturi at next fuel injection time, also causing a delay in generating negative pressure.

Since the volume of the venturi and the volume of the vaporizing chamber are set as above, the fuel is allowed to be reliably collected in the inlet port of the venturi when the fuel injection from the nozzle is stopped. As a result, the fuel injected from the nozzle instantly sticks to the wall surface of the venturi, shielding the vaporizing chamber from the outside. This configuration can immediately generate sufficient negative pressure in the vaporizing chamber.

In the fuel vapor pressure measuring device according to the invention, preferably, the fuel vapor generating section includes an end plate for interrupting a flow of fuel flowing out of the venturi, the end plate being located near the outlet port of the venturi.

The above end plate can interrupt a flow of the fuel flowing out of the venturi and therefore allows the fuel to be collected in the venturi. As a result, the fuel injected from the nozzle instantly sticks to the wall surface of the inlet port of the venturi, shielding the vaporizing chamber from the outside. This configuration can immediately generate sufficient negative pressure in the vaporizing chamber.

In the fuel vapor pressure measuring device according to the invention, preferably, an inlet port of the venturi is located below an uppermost position of the end plate in a gravity direction.

As above, the inlet port of the venturi is located below the uppermost position of the end plate in the gravity direction, providing an enhanced effect of the end plate, so that the fuel is allowed to be collected more reliably in the venturi.

In the fuel vapor pressure measuring device according to the invention, preferably, the fuel vapor generating section includes a check valve for preventing a fuel flow from the outlet port to the inlet port of the venturi, the check valve being placed in the venturi.

In the above configuration, the check valve can serve to reliably collect fuel in the inlet port of the venturi. Consequently, the fuel injected from the nozzle instantly sticks to the wall surface of the inlet port of the venturi, shielding the vaporizing chamber from the outside. This configuration can immediately generate sufficient negative pressure in the vaporizing chamber.

In the fuel vapor pressure measuring device according to the invention, the fuel vapor generating section may be configured such that the outlet port of the venturi is located below the inlet port of the venturi in a gravity direction and a fuel reservoir is provided in the outlet port of the venturi.

In the case where the outlet port of the venturi is located below the inlet port in the gravity direction, that is, even in the case where the venturi is placed to extend downward, the fuel reservoir can serve to fill the fuel in the venturi as soon as the fuel is injected from the nozzle. Accordingly, the fuel injected from the nozzle sticks to the wall surface of the inlet port of the venturi, shielding the vaporizing chamber from the outside. This configuration can also immediately generate sufficient negative pressure in the vaporizing chamber.

A fuel injection control system is preferably configured to include one of the aforementioned vapor pressure measuring devices, and a fuel injection control means for performing a fuel injection control in the fuel injection device, the fuel injection control means being arranged to perform the fuel injection control in the fuel injection device of the internal combustion engine by calculating the vapor pressure at a water temperature during startup based on a fuel vapor characteristic value such as the Reid vapor pressure obtained by the vapor pressure measuring device and a cooling water temperature of the internal combustion engine.

The fuel injection control system configured as above allows can correct the fuel injection amount to an optimum value required by an engine according to fuel types and temperatures. Accordingly, a constantly stable combustion state is achieved. In particular, HC reduction, startability, and driveability during non-operating time of the A/F sensor (during open control) during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

In this fuel injection control system, the vapor pressure at startup is calculated based on the cooling water temperature in the internal combustion engine. Accordingly, even at re-startup time after warm-up of the internal combustion engine, the fuel injection control can be performed accurately.

The above fuel injection control system includes the aforementioned vapor pressure measuring device having a simple and compact configuration, so that the system itself can be simplified and downsized. Thereby, a high-performance fuel injection control system can be realized.

To solve the above problems, the invention provides a fuel vapor pressure measuring device comprising: a fuel tank for storing fuel to be supplied to an internal combustion engine; a fuel pump for supplying the fuel in the fuel tank to a fuel injection device; a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber; a first fuel path that connects the fuel pump and the fuel injection device; a second fuel path having one end connected to the fuel pump or the first fuel path and the other end connected to the fuel vapor generating section; pressure detection means for detecting pressure of the fuel vapor generating section; and fuel temperature detection means for detecting a temperature of fuel allowed to pass through the fuel vapor generating section; characteristic storage means for storing fuel vapor characteristic obtained based on a detection result of the pressure detection means and a detection result of the fuel detection means; vapor pressure calculation means for calculating fuel vapor pressure based on the fuel vapor characteristic stored in the characteristic storage means and the fuel temperature detected by the fuel temperature detection means.

Herein, the fuel vapor characteristic can specify a vapor pressure curve (a fuel type). Concretely, an example is two parameters, that is, a detection value (a vapor pressure) of the pressure detection means and a detection value (a fuel temperature) of the fuel temperature detection means or another example is a typical value such as a vapor pressure and a Reid vapor pressure at a specific temperature converted from the vapor pressure and the fuel temperature.

In this fuel vapor pressure measuring device, there are provided the first fuel path for supplying fuel from the fuel pump to the fuel injection device and the second fuel path for supplying fuel from the fuel pump or the first fuel path to the fuel vapor generating section. Accordingly, the fuel is supplied to the second fuel path directly from the fuel pump or through the first fuel path. The fuel flowing in the second fuel path then reaches the nozzle. Herein, the nozzle has a diaphragm and thus the fuel injected from the nozzle is supplied at an increased flow velocity to the vaporizing chamber, passes through the venturi, and then returns to the fuel tank. At that time, when passes through the throat part of the venturi, the fuel injected from the nozzle generates negative pressure in the vaporizing chamber. This is because the fuel in the vaporizing chamber is pulled by the influence of viscosity when the fuel passes through the throat part of the venturi, thereby generating negative pressure in the vaporizing chamber.

This negative pressure generating action causes the fuel to vaporize under the reduced pressure, thereby generating the vapor pressure in the vaporizing chamber. The pressure of the vaporizing chamber thus comes to an equilibrium state based on the fuel vapor pressure. At that time, the internal pressure of the vaporizing chamber in the equilibrium state is detected by the pressure detection means. Furthermore, the temperature of fuel allowed to pass through the fuel vapor generating section is detected by the fuel temperature detection means. Then, the characteristic storage means stores the fuel vapor characteristic obtained from the detection result of the pressure detection means and the detection result of the fuel temperature detection means.

According to the vapor pressure measuring device, as above, the fuel injected at the increased flow velocity by the diaphragm of the nozzle generates negative pressure in the vaporizing chamber and thus is vaporized under the reduced pressure. The internal pressure of the vaporizing chamber in the equilibrium state caused by the generated vapor pressure is detected by the pressure detection means. At that time, the temperature of the fuel being supplied to the fuel vapor generating section is detected by the fuel temperature detection means. The fuel vapor characteristic obtained from those detection values is stored in the characteristic storage means.

In the above vapor pressure measuring device, when the fuel vapor characteristic is stored, the vapor pressure calculation means calculates the fuel vapor pressure at the time based on the stored fuel vapor characteristic and the fuel temperature at the time. According to this vapor pressure measuring device, therefore, there is no need to constantly detect the pressure of the vaporizing chamber and the fuel temperature. In other words, it is only necessary to detect the pressure of the vaporizing chamber and the fuel temperature only when the fuel vapor characteristic is to be detected and stored in the characteristic storage means. This makes it possible to prevent deterioration of the pressure detection means and the fuel temperature detection means and also reduce electric power consumption. Consequently, the fuel vapor pressure can be stably and accurately measured and deterioration of fuel consumption in the internal combustion engine can be prevented.

To solve the above problems, another aspect of the invention provides a fuel vapor pressure measuring device comprising: a fuel tank for storing fuel to be supplied to an internal combustion engine; a fuel pump for supplying the fuel in the fuel tank to a fuel injection device; a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber; a first fuel path that connects the fuel pump and the fuel injection device; a second fuel path having one end connected to the fuel pump or the first fuel path and the other end connected to the fuel vapor generating section; pressure detection means for detecting pressure of the fuel vapor generating section; fuel temperature detection means for detecting a temperature of fuel allowed to pass through the fuel vapor generating section; coolant temperature detection means for detecting a temperature of coolant to cool the internal combustion engine; characteristic storage means for storing fuel vapor characteristic obtained based on a detection result of the pressure detection means and a detection result of the fuel detection means; vapor pressure calculation means for calculating fuel vapor pressure based on the fuel vapor characteristic stored in the characteristic storage means and a coolant temperature detected by the coolant temperature detection means.

It is to be noted that, as mentioned above, the fuel vapor characteristic can specify a vapor pressure curve (a fuel type). Concretely, an example is two parameters, that is, a detection value (a vapor pressure) of the pressure detection means and a detection value (a fuel temperature) of the fuel temperature detection means or another example is a typical value such as a vapor pressure and a Reid vapor pressure at a specific temperature converted from the vapor pressure and the fuel temperature.

In the above fuel vapor pressure measuring device, there are also provided the first fuel path for supplying fuel from the fuel pump to the fuel injection device and the second fuel path for supplying fuel from the fuel pump or the first fuel path to the fuel vapor generating section. Accordingly, the fuel is supplied to the second fuel path directly from the fuel pump or through the first fuel path. The fuel flowing in the second fuel path then reaches the nozzle. Herein, the nozzle has a diaphragm and thus the fuel injected from the nozzle is supplied at an increased flow velocity into the vaporizing chamber, passes through the venturi and returns to the fuel tank. At that time, when passes through the throat part of the venturi, the fuel injected from the nozzle generates negative pressure in the vaporizing chamber.

This negative pressure generating action causes the fuel to vaporize under the reduced pressure, thereby generating the vapor pressure in the vaporizing chamber. The pressure of the vaporizing chamber thus comes to an equilibrium state based on the fuel vapor pressure. At that time, the internal pressure of the vaporizing chamber in the equilibrium state is detected by the pressure detection means. Furthermore, the temperature of fuel allowed to pass through the fuel vapor generating section is detected by the fuel temperature detection means. Then, the characteristic storage means stores the fuel vapor characteristic obtained from the detection result of the pressure detection means and the detection result of the fuel temperature detection means.

In the above vapor pressure measuring device, when the fuel vapor characteristic is stored, the vapor pressure calculation means calculates the fuel vapor pressure at the time based on the stored fuel vapor characteristic and the coolant temperature at the time. According to the vapor pressure measuring device, therefore, there is no need to constantly detect the pressure of the vaporizing chamber and the fuel temperature. In other words, it is only necessary to detect the pressure of the vaporizing chamber and the fuel temperature only when the fuel vapor characteristic is to be detected and stored in the characteristic storage means. This makes it possible to prevent deterioration of the pressure detection means and the fuel temperature detection means and also reduce electric power consumption. Consequently, the fuel vapor pressure can be stably and accurately measured and deterioration of fuel consumption in the internal combustion engine can be prevented.

Herein, the fuel vapor pressure required to be taken into account for control of the internal combustion engine is a value in the internal combustion engine (a combustion chamber). When the fuel vapor pressure is to be calculated after the fuel vapor characteristic is stored, this fuel vapor pressure measuring device refers to a coolant temperature which is a temperature index value of the internal combustion engine, not a fuel temperature, thereby an approximate value to a fuel vapor pressure in the internal combustion engine (the combustion chamber) can be calculated. This enhances the control accuracy of the internal combustion engine.

To solve the above problems, another aspect of the invention provides a fuel vapor pressure measuring device comprising: a fuel tank for storing fuel to be supplied to an internal combustion engine; a fuel pump for supplying the fuel in the fuel tank to a fuel injection device; coolant temperature detection means for detecting a temperature of coolant to cool the internal combustion engine; a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber; a first fuel path that connects the fuel pump and the fuel injection device; a second fuel path having one end connected to the fuel pump or the first fuel path and the other end connected to the fuel vapor generating section; pressure detection means for detecting pressure of the fuel vapor generating section; fuel temperature detection means for detecting a temperature of fuel allowed to pass through the fuel vapor generating section; characteristic storage means for storing fuel vapor characteristic obtained based on a detection result of the pressure detection means and a detection result of the coolant temperature detection means; vapor pressure calculation means for calculating fuel vapor pressure based on the fuel vapor characteristic stored in the characteristic storage means and a coolant temperature detected by the coolant temperature detection means.

It is to be noted that, as mentioned above, the fuel vapor characteristic can specify a vapor pressure curve (a fuel type). Concretely, an example is two parameters, that is, a detection value (a vapor pressure) of the pressure detection means and a detection value (a fuel temperature) of the fuel temperature detection means or another example is a typical value such as a vapor pressure and a Reid vapor pressure at a specific temperature converted from the vapor pressure and the fuel temperature.

In the above fuel vapor pressure measuring device, there are also provided the first fuel path for supplying fuel from the fuel pump to the fuel injection device and the second fuel path for supplying fuel from the fuel pump or the first fuel path to the fuel vapor generating section. Accordingly, the fuel is supplied to the second fuel path directly from the fuel pump or through the first fuel path. The fuel flowing in the second fuel path then reaches the nozzle. Herein, the nozzle has a diaphragm and thus the fuel injected from the nozzle is supplied at an increased flow velocity into the vaporizing chamber, passes through the venturi and returns to the fuel tank. At that time, when passes through the throat part of the venturi, the fuel injected from the nozzle generates negative pressure in the vaporizing chamber.

This negative pressure generating action causes the fuel to vaporize under the reduced pressure, thereby generating the vapor pressure in the vaporizing chamber. The pressure of the vaporizing chamber thus comes to an equilibrium state based on the fuel vapor pressure. At that time, the internal pressure of the vaporizing chamber in the equilibrium state is detected by the pressure detection means. The coolant temperature of the internal combustion engine is detected by the coolant temperature detection means. Then, the characteristic storage means stores the fuel vapor characteristic obtained from the detection result of the pressure detection means and the detection result of the coolant temperature detection means.

In the above vapor pressure measuring device, when the fuel vapor characteristic is stored, the vapor pressure calculation means calculates the fuel vapor pressure at the time based on the stored fuel vapor characteristic and the coolant temperature at the time (at the time of calculation of vapor pressure). Accordingly, an approximate value to the vapor pressure of the internal combustion engine (the combustion chamber) can be calculated, thereby enhancing the control accuracy of the internal combustion engine. According to the above vapor pressure measuring device, there is no need to constantly detect the pressure of the vaporizing chamber and the fuel temperature. In other words, it is only necessary to detect the pressure of the vaporizing chamber only when the fuel vapor characteristic is to be detected and stored in the characteristic storage means. This makes it possible to prevent deterioration of the pressure detection means and also reduce electric power consumption. Consequently, the fuel vapor pressure can be stably and accurately measured and deterioration of fuel consumption in the internal combustion engine can be prevented. The above vapor pressure measuring device doe not need to include the fuel temperature detection means and therefore can achieve a cost reduction and a size reduction.

In the fuel vapor pressure measuring device of the invention, preferably, the characteristic storage means stores Reid vapor pressure as the fuel vapor characteristic.

This configuration can facilitate arithmetic processing and storage in the vapor pressure measuring device and accurately measure the fuel vapor pressure. Storing two parameters; the detection value (the vapor pressure) of the pressure detection means and the detection value (the fuel temperature) of the fuel temperature detection means allow the measurement accuracy of the fuel vapor pressure to remain unchanged. However, it is inefficient in arithmetic processing and storage in the vapor pressure measuring device. Furthermore, when the vapor pressure at the specific temperature is stored instead of the Reid vapor pressure, it can facilitate the arithmetic processing and the storage in the vapor pressure measuring device but may decrease the measurement accuracy of the fuel vapor pressure.

In the fuel vapor pressure measuring device of the invention, preferably, the characteristic storage means updates the fuel vapor characteristic at a constant time interval, the vapor pressure calculation means calculates the fuel vapor pressure based on the updated fuel vapor characteristic and the temperature detected by the fuel temperature detection means or the coolant temperature detection means.

The fuel vapor pressure may change (change with time) by fuel oxidization, fuel vaporization, and others. Therefore, the characteristic storage means updates the fuel vapor characteristic at regular intervals and the vapor pressure calculation means calculates the fuel vapor pressure by use of the updated fuel vapor characteristic. This is responsive to the change in fuel property with time. In other words, such configuration can reduce electric power consumption while preventing deterioration of the pressure detection means and the fuel temperature detection means and also accurately measure the fuel vapor pressure even in case the fuel property changes with time.

In the fuel vapor pressure measuring device of the invention, preferably, the characteristic storage means updates the fuel vapor characteristic every time the internal combustion engine is started.

Since the fuel vapor characteristic is updated every time the internal combustion engine is started, it can reliably respond to the change in fuel property with time occurring during nonoperation of the internal combustion engine.

In the fuel vapor pressure measuring device of the invention, preferably, the characteristic storage means updates the fuel vapor characteristic when the fuel tank is replenished with fuel.

Since the fuel vapor characteristic is updated when the fuel tank is replenished with fuel, it can respond to the change in fuel property due to fuel replenishment.

In the fuel vapor pressure measuring device of the invention, preferably, the characteristic storage means stores the fuel vapor characteristic under an operating condition of the internal combustion engine that an injection amount from the fuel injection device decreases.

Under the operating condition of the internal combustion engine at which the fuel injection amount from the fuel injection device decreases, for example, at idle or at deceleration, the fuel vapor characteristic is stored in the characteristic storage means. Accordingly, it is unnecessary to increase the size of the fuel pump for supplying the fuel to the fuel vapor generating section and also reduce the influence to the fuel injection in the fuel injection device.

Preferably, the fuel vapor pressure measuring device of the invention further comprises a control valve for controlling inflow of fuel into the nozzle, the control valve being placed upstream or downstream of the nozzle, wherein the control valve is opened when the fuel vapor characteristic stored in the characteristic storage means is to be obtained.

The above configuration can supply the fuel (inject the fuel from the nozzle) to the fuel vapor generating section only when the fuel vapor characteristic stored in the characteristic storage means is to be obtained. This can reduce the influence to the fuel injection in the fuel injection device.

By use of the vapor pressure measured in the fuel vapor pressure measuring device, the fuel injection amount may be corrected to bring the internal combustion engine to an optimum operating state. To be concrete, it may be arranged to include one of the aforementioned fuel vapor pressure measuring devices and operation control means for controlling an operating state of the internal combustion engine, wherein the operation control means corrects a fuel injection amount in the fuel injection device based on a fuel vapor pressure calculated by the vapor pressure calculation means.

As above, since the fuel injection amount can be corrected to an optimum value required by the internal combustion engine according to fuel types and temperatures, a stable combustion state is constantly achieved. In particular, HC reduction, startability, and driveability during non-operating time of the AIF sensor (during open control) during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

Alternatively, it may be arranged to include one of the aforementioned fuel vapor pressure measuring device and operation control means for controlling an operating state of the internal combustion engine, wherein the operation control means corrects an ignition timing of the internal combustion engine based on the fuel vapor pressure calculated by the vapor pressure calculation means.

This configuration can correct the ignition timing to an optimum timing required by the internal combustion engine according to fuel types and temperatures. Consequently, a stable combustion state is constantly achieved. In particular, HC reduction, startability, and driveability during non-operating time of the AIF sensor (during open control) during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

### ADVANTAGEOUS EFFECTS OF INVENTION

According to the fuel vapor pressure measuring device of the invention, as described above, the vapor pressure can be accurately calculated without any external influence. Furthermore, the fuel injected from the nozzle immediately sticks to the wall surface in the inlet port of the venturi, shielding the vaporizing chamber from the outside. A sufficient negative pressure can therefore be generated in the vaporizing chamber. As a result, the vapor pressure can be accurately calculated without loss of responsivity. Moreover, the deterioration of the detection means can be prevented and also electric power consumption can be reduced.

### BRIEF DESCRIPTION OF DRAWINGS

FIG. 1 is a schematic configuration view of a fuel supply system in a first embodiment;

FIG. 2 is a cross sectional view showing a schematic configuration of a fuel vapor generating section;

FIG. 3 is an explanatory view showing a concept of an arithmetic processing of Reid vapor pressure;

FIG. 4 is an explanatory view showing a concept of fuel supply control at engine startup;

FIG. 5 is a flowchart showing the details at the engine startup;

FIG. 6 is a flowchart showing the details of a Reid vapor pressure measurement routine;

FIG. 7 is a graph showing a relationship between an injection flow amount from a nozzle and pressure of a vaporizing chamber;

FIG. 8 is a graph showing a relationship between the pressure of the vaporizing chamber and Reid vapor pressure;

FIG. 9 is a graph showing a relationship between fuel temperature and temperature coefficient;

FIG. 10 is a view showing a fuel vapor generating section with a fuel temperature sensor placed at the bottom of a reserve cup;

FIG. 11 is a view showing a modified example of the fuel vapor generating section;

FIG. 12 is a view showing another modified example of the fuel vapor generating section;

FIG. 13 is a view showing another modified example of the fuel vapor generating section;

FIG. 14 is a schematic configuration view of a main part of a fuel supply system in a second embodiment;

FIG. 15 is a flowchart showing the details of a Reid vapor pressure measurement routine;

FIG. 16 is a schematic configuration view of a main part of a fuel supply system in a third embodiment;

FIG. 17 is a cross sectional view showing a schematic configuration of a fuel vapor generating section;

FIG. 18 is a view showing a main part of a fuel supply system in which a first fuel path is connected to a second fuel path; and

FIG. 19 is a view showing a fuel vapor generating section with an electromagnetic valve is placed upstream of a vaporizing chamber.

### DESCRIPTION OF EMBODIMENTS

A detailed description of a preferred embodiment of a fuel vapor pressure measuring device and a fuel injection control system embodying the present invention will now be given referring to the accompanying drawings. In the present embodiment, the invention is applied to a fuel supply system of a vehicle engine.

### First Embodiment

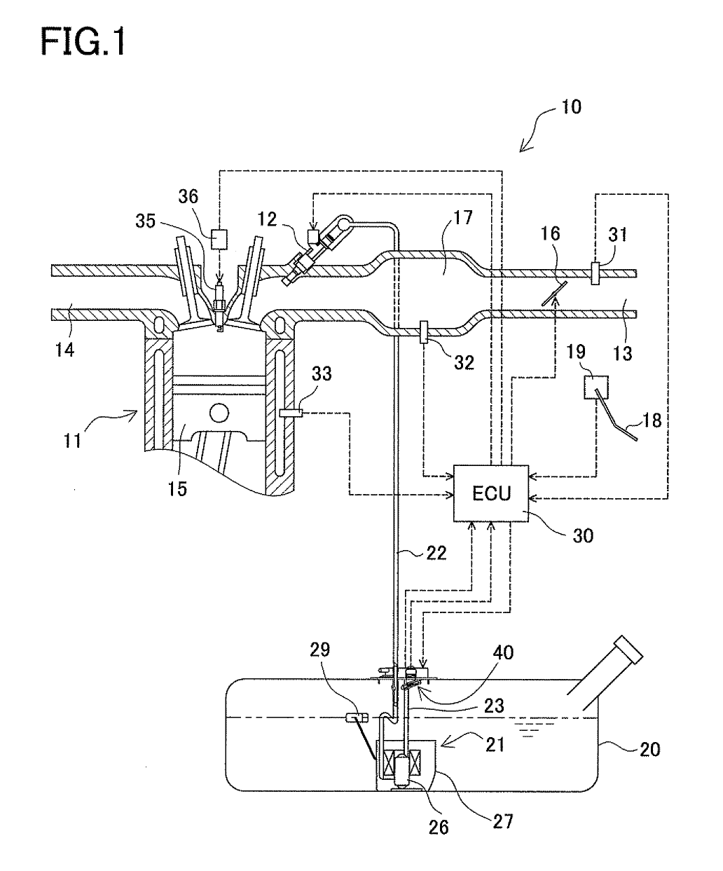

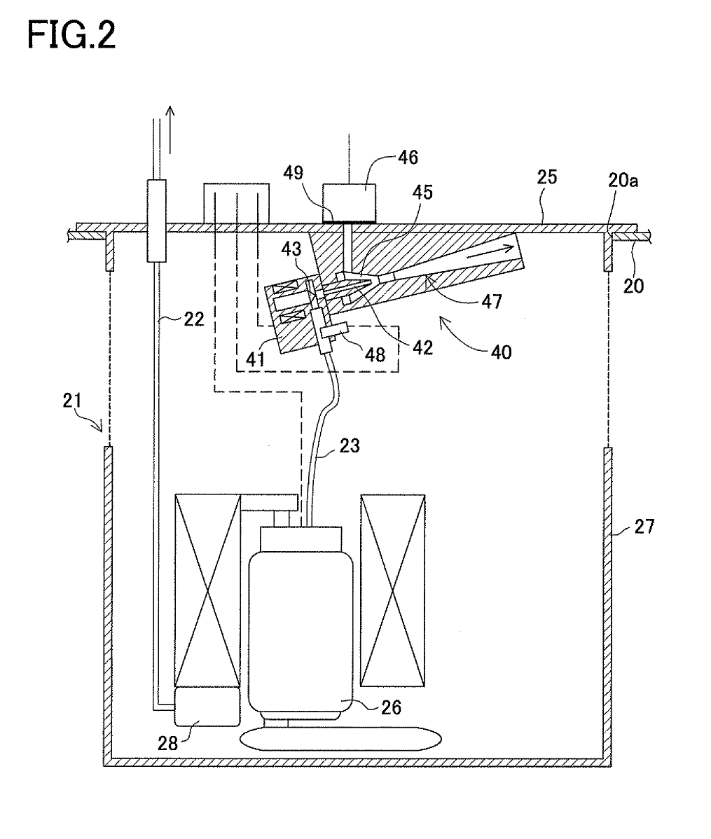

A first embodiment will be first explained. A fuel supply system in the first embodiment is explained referring to FIGS. 1 and 2. FIG. 1 is a schematic configuration view of the fuel supply system in the first embodiment. FIG. 2 is a partial cross sectional view of a schematic configuration of a fuel vapor generating section. A fuel supply system 10 includes, as shown in FIG. 1, an engine 11, an injector 12, a fuel tank 20, a fuel pump unit 21, a first fuel path 22, a second fuel path 23, and a control unit (ECU) 30. Accordingly, the fuel supply system 10 is configured to supply the fuel in the fuel tank 20 from the fuel pump unit 21 to the injector 12 through the first fuel path 22 in response to a command from the ECU 30 so that the injector 12 injects and supplies the fuel to the engine 11.

Herein, the engine 11 is a reciprocal type engine having a known structure. This engine 11 is arranged to explode and burn combustible gas mixture of air taken in through an intake path 13 and the fuel injected from the injector 12 by igniting the gas mixture with an ignition plug 35, and exhaust burnt exhaust gas through an exhaust path 14, thereby operating a piston 15 to rotate a crank shaft (not shown) to produce power. The engine 11 is provided with a water temperature sensor 33. This sensor 33 detects the temperature of cooling water (cooling water temperature) flowing through the engine 11 and outputs an electrical signal representing a detection value thereof. The output signal from the water temperature sensor 33 is transmitted to the ECU 30.

The intake path 13 is provided with an air flow meter 31, a throttle valve 16, and a surge tank 17. Herein, the air flow meter 31 detects an amount of air (intake amount) to be taken into the engine 11 and outputs an electrical signal representing a detection value thereof. The throttle valve 16 is operated to open and close to regulate the air amount (the intake amount) to be taken into the engine 11 through the intake path 13. This valve 16 is interlocked with the operation of an accelerator pedal 18 provided in a driver side and more particularly is operated according to an output signal from an accelerator position sensor 19 provided at the accelerator pedal 18. Furthermore, an intake pressure sensor 32 is placed in a surge tank 17. This intake pressure sensor 32 detects intake pressure in the intake path 13 downstream of the throttle valve 16 and outputs an electrical signal representing a detection value thereof. The output signals from the air flow meter 31 and the intake pressure sensor 32 are transmitted to the ECU 30.

The injector 12 is configured to inject fuel into an intake port of each cylinder of the engine 11. The injector 12 is supplied with the fuel pressure-fed from the fuel pump unit 21 through the first fuel path 22. The thus supplied fuel is injected to the intake port by activation of the injector 12 based on a command from the ECU 30, thereby forming a combustible gas mixture with air, which is taken in each cylinder. A pressure regulator 28 mentioned later controls the fuel injection pressure to a constant level. Thus, surplus fuel is returned into the fuel tank 20 through a jet pump provided in the fuel pump unit 21.

The fuel tank 20 contains fuel and is internally provided with the fuel pump unit 21. This fuel pump unit 21 includes a reserve cup 27 accommodating a fuel pump 26 and others and is assembled with a set plate 25 that closes a mounting hole 20a of the fuel tank 20 as shown in FIG. 2. This reserve cup 27 is one example of a “sub-tank” of the invention. In the present embodiment, the fuel tank 20 is made of resin and hence the reserve cup is provided. As an alternative, in the case of an iron fuel tank, a sub-tank is formed by a partition wall of the tank.

The fuel pump unit 21 is mounted in the fuel tank 20 by attaching the set plate 25 to the fuel tank 20 so that the set plate 25 closes the mounting hole 20a of the fuel tank 20. The fuel whose pressure is controlled to be constant by a pressure regulator 28 is supplied from the fuel pump unit 21 to the first fuel path 22 and the second fuel path 23. Accordingly, a fuel injection condition from a nozzle 42 mentioned later can be made constant and thus the fuel can be vaporized under the same condition in a vaporizing chamber 45 mentioned later.

Furthermore, the fuel pump unit 21 is connected to a float 29 for detecting a remaining amount of fuel in the fuel tank 20. A signal representing the position (the height) of this float 29 is input to the ECU 30. Based on that signal, the fuel remaining amount and the presence/absence of fuel supply is detected.

The ignition plug 35 provided in the engine 11 performs an ignition operation upon receipt of a high voltage output from an igniter 36. Ignition timing of the ignition plug 35 is determined based on output timing of the high voltage from the igniter 36 determined by a command of the ECU 30.

The ECU 30 shown in FIG. 1 receives various signals output from various sensors such as a crank angle sensor in addition to the above sensors. The ECU 30 detects an operating state of the engine based on those input signals and controls the fuel pump 26, the injector 12, and the igniter 36 respectively to execute fuel supply control, ignition timing control, and others according to the operating state of the engine. Specifically, the ECU 30 corresponds to “operation control means” of the invention. The fuel supply control is defined as controlling an injection amount of the fuel pump 26 (the number of revolutions of a pump motor), an amount of fuel (a fuel injection amount) to be injected from the injector 12, and an injection timing thereof according to the engine operating state. The ignition timing control is defined as controlling the ignition timing of the ignition plug 35 by controlling the igniter 36 according to the operating state of the engine 11.

The ECU 30 is further configured to calculate and store the Reid vapor pressure as a fuel vapor characteristic based on each output signal from a pressure sensor 46 and a fuel temperature sensor 48 mentioned later. That is, the ECU 30 is one example of “fuel vapor characteristic storage means” of the invention. Furthermore, the ECU 30 is arranged to calculate fuel vapor pressure based on the stored Reid vapor pressure and a cooling water temperature detected by the water temperature sensor 33 or a fuel temperature detected by the fuel temperature sensor 48. That is, the ECU 30 is also one example of “vapor pressure calculation means” of the invention.

Herein, the ECU 30 includes a known structure, i.e., a central processing unit (CPU), a read only memory (ROM), a random access memory (RAM), a backup RAM, an external input circuit, an external output circuit, and others. The ECU 30 provides a logic-arithmetic circuit in which the CPU, ROM, RAM, and backup RAM are connected to the external input circuit, external output circuit, and others through bus(es). The ROM has stored in advance a predetermined control program related to engine control. The RAM temporarily stores a calculation result of the CPU. The backup RAM saves previously stored data. The CPU executes various controls according to the predetermined control program based on detection values transmitted from various sensors through an input circuit.

On a fuel tank side of the set plate 25, i.e., in the fuel tank 20, more specifically, in the reserve cup 27, the fuel vapor generating section 40 is placed. Since the fuel vapor generating section 40 is placed in the fuel tank 20, some amount of fuel even if leaks from the fuel vapor generating section 40 will not cause any problem. Thus, the structure of the fuel vapor generating section 40, particularly, a sealing structure can be made simple. The fuel vapor generating section 40 also can be combined with the fuel pump 26 and others into a module, enabling easy attachment. A mounting member thereof can be simplified. In the present embodiment, the fuel vapor generating section 40 is integrated with the set plate 25.

This fuel vapor generating section 40 includes an electromagnetic valve 41, a nozzle 42, a vaporizing chamber 45, and a venturi 47 as shown in FIG. 2. An inlet port of the electromagnetic valve 41 is connected to the second fuel path 23 and an outlet port of the same is connected to the nozzle 42. A valve element 43 of the electromagnetic valve 41 is moved by ON/OFF of energization to the electromagnetic valve 41, thereby controlling fuel injection from the nozzle 42 to the vaporizing chamber 45. Such electromagnetic valve 41 allows fuel to be injected from the nozzle 42 only during measurement of fuel vapor pressure, thereby reliably generating negative pressure in the vaporizing chamber 45. This makes it possible to measure the fuel vapor pressure when the fuel injection amount is low and thus accurately measure the fuel vapor pressure without increasing a flow rate of the fuel pump 26, and also reduce the influence on the fuel injection amount of the injector 12. This electromagnetic valve 41 is connected to the ECU 30 as shown in FIG. 1 so that energization to the electromagnetic valve 41 is turned ON/OFF based on the command from the ECU 30.

Herein, in the fuel vapor generating section 40, the venturi 47 is positioned to extend obliquely upward, that is, an inlet port of the venturi 47 is positioned below an outlet port of the same in a gravity direction. Accordingly, the inlet port of the venturi 47 can store the fuel therein.

The vaporizing chamber 45 is formed around the nozzle 42 and between the nozzle 42 and the venturi 47 as shown in FIG. 2. In the present embodiment, the diameter of the nozzle 42 is 0.9 mm, the diameter of a throat part of the venturi 47 is 1.5 mm, and the distance between the nozzle 42 and the venturi 47 is 3 mm. Those values are determined according to the performance of the fuel pump and are not limited to the above.

Herein, the vaporizing chamber 45 is normally in negative pressure state while fuel is being injected from the nozzle 42. When the injection is stopped, the vaporizing chamber 45 attempts to return to atmospheric pressure, and the fuel on the venturi 47 side is returned to the vaporizing chamber 45 side. At that time, if the space volume of the venturi 47 is smaller than the space volume of the vaporizing chamber 45, the fuel disappears from the inlet port of the venturi 47, thus leading to a delay for the fuel to stick to the inlet port 47 at the next fuel injection time, also causing a delay in creating negative pressure.

Accordingly, in the fuel vapor generating section 40, the space volume of the venturi 47 is designed to be larger than the space volume of the vaporizing chamber 45. This configuration can reliably reserve some fuel in the inlet port of the venturi 47 when the fuel injection from the nozzle 42 is stopped.

The vaporizing chamber 45 is connected to a pressure sensor 46 through a diaphragm 49 to detect the internal pressure of the vaporizing chamber 45. Thus, the pressure sensor 46 detects the internal pressure of the vaporizing chamber 45 when the fuel is boiled under reduced pressure and vapor pressure is generated by the negative pressure created in the vaporizing chamber 45. The diaphragm 49 prevents entrance of the fuel into the pressure sensor 46 to avoid the occurrence of circuit troubles in the pressure sensor 46. An output signal from the pressure sensor 46 is transmitted to the ECU 30 as shown in FIG. 1.

The reason why the fuel is boiled under reduced pressure in the vaporizing chamber 45 as mentioned above is as follows. The fuel injected from the nozzle 42 is supplied to the vaporizing chamber 45 and returned into the reserve cup 27 after passing through the venturi 47. At the time when the fuel injected from the nozzle 42 passes through the throat part of the venturi 47, the fuel in the vaporizing chamber 45 is pulled outside (toward the venturi side) by the influence of fuel viscosity, thereby generating negative pressure in the vaporizing chamber 45. This negative pressure generating action causes the fuel in the vaporizing chamber 45 to vaporize under reduced pressure, thereby generating the vapor pressure in the vaporizing chamber 45. The pressure of the vaporizing chamber 45 comes to an equilibrium state based on the fuel vapor pressure. At that time, the internal pressure of the vaporizing chamber 45 in the equilibrium state is detected by the pressure sensor 46.

The pressure sensor 46 is placed outside the fuel tank 20, more specifically, on an outer side of the set plate 25 (on an opposite side from the tank). Thus, wiring to the pressure sensor 46 is facilitated. Since the fuel flowing out of the venturi 47 is returned into the reserve cup 27, the fuel pump 26 placed in the reserve cup 27 can reliably pump up and supply the fuel even if the fuel pump 26 tilts.

As shown in FIG. 2, furthermore, the fuel temperature sensor 48 is provided at the inlet port of the fuel vapor generating section 40 (the electromagnetic valve 41). This can detect exactly the temperature of fuel to be injected from the nozzle 42. An output signal from the fuel temperature sensor 48 is transmitted to the ECU 30 as shown in FIG. 1. The fuel temperature sensor 48 is integrally attached to the fuel vapor generating section 40. Accordingly, constituent components of the fuel vapor generating section 40 are concentrated (integrated) so that mounting easiness of the fuel vapor generating section 40 can be more enhanced.

As above, the Reid vapor pressure RVP is calculated in an after-mentioned manner based on the pressure and the fuel temperature detected by the fuel vapor generating section 40. In other words, the fuel vapor generating section 40 can vaporize fuel under reduced pressure and calculate the Reid vapor pressure RVP, and also calculate the fuel vapor pressure at a temperature during startup. Accordingly, the system configuration can be simplified and downsized and further can be configured to perform high-accurate fuel injection control.

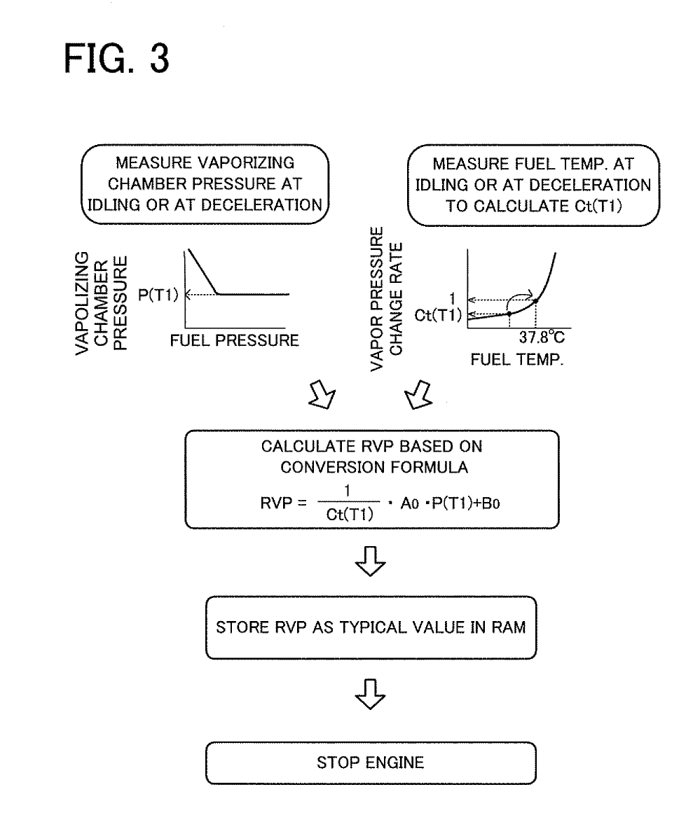

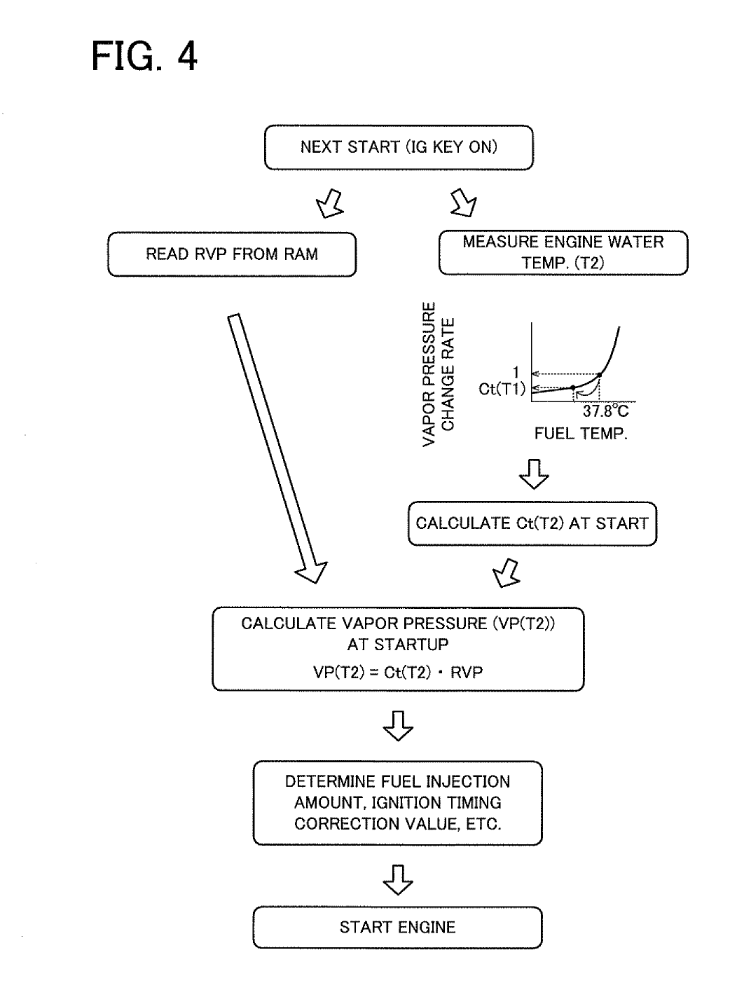

The following brief explanation is given to a concept of calculation of vapor pressure executed in the fuel supply system 10 and fuel supply control using it at engine startup time, referring to FIGS. 3 and 4. FIG. 3 is an explanatory view of a concept of an arithmetic processing of Reid vapor pressure and FIG. 4 is an explanatory view of a concept of the fuel supply control at engine startup time.

As shown in FIG. 3, at idling or at deceleration following engine startup, a pressure P(T1) of the vaporizing chamber is detected, and also a fuel temperature is detected and a vapor pressure change rate (temperature coefficient) Ct(T1) is calculated. Then, the Reid vapor pressure RVP is calculated based on a conversion formula. It is to be noted that the details of the conversion formula for calculating the Reid vapor pressure will be described later. Then, this Reid vapor pressure RVP is stored as a typical value in the RAM. Thus, it is only necessary to store one value as an index representing the fuel property in the fuel tank, so that subsequent processing (calculation, storage, etc.) can be facilitated. As the fuel vapor characteristic, instead of storing the Reid vapor pressure, it may be arranged to directly store the vaporizing chamber pressure and the fuel temperature or store a vapor pressure at a specific temperature calculated from the vaporizing chamber pressure and the fuel temperature. Storing such two parameters, i.e., the vaporizing chamber pressure and the fuel temperature, will not decrease the measurement accuracy of the fuel vapor pressure but will be inefficient in arithmetic processing and storage in the vapor pressure measuring device. On the other hand, storing the vapor pressure at the specific temperature will be efficient in arithmetic processing and storage in the vapor pressure measuring device but may decrease the measurement accuracy of fuel vapor pressure.

At the time of next engine startup, as shown in FIG. 4, the Reid vapor pressure RVP stored at the time of previous engine operation is read, and an engine water temperature is detected and a vapor pressure change rate (a temperature coefficient) Ct(T2) is calculated. Then, a vapor pressure VP(T2) at the time of engine startup is calculated based on the conversion formula. The details of the conversion formula for calculating the vapor pressure will be mentioned later. Based on the calculated vapor pressure, subsequently, correction values of the fuel injection amount and the ignition timing are determined respectively. The engine is started with the corrected injection amount and corrected ignition timing:

In the fuel supply system 10, as above, the Reid vapor pressure RVP is calculated and stored. A fuel vapor pressure VP(T2) is then calculated based on the stored Reid vapor pressure RVP and a cooling water temperature T2 at the time. Accordingly, there is no need to constantly detect the pressure of the vaporizing chamber and the fuel temperature in order to calculate the fuel vapor pressure VP(T2) and hence the pressure sensor and the fuel temperature sensor can be prevented from deteriorating and the power consumption of the system can be reduced. Therefore, the fuel vapor pressure VP(T2) can be stably accurately measured and also a decrease in fuel efficiency can be avoided. The fuel temperature may be used instead of the cooling water temperature to calculate the fuel vapor pressure VP(T2). However, calculation of the fuel vapor pressure VP using the cooling water temperature enables calculation of fuel vapor pressure VP more responsive to the temperature state of the engine 11 and thus enables execution of more appropriate fuel supply control and ignition timing control.

By control of the fuel supply system 10, the fuel injection and the ignition timing can be corrected to optimum values required by the engine according to fuel types and temperatures. Consequently, a stable combustion state is constantly achieved. In particular, HC reduction, startability, and driveability during non-operating time of the A/F sensor (during open control) during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

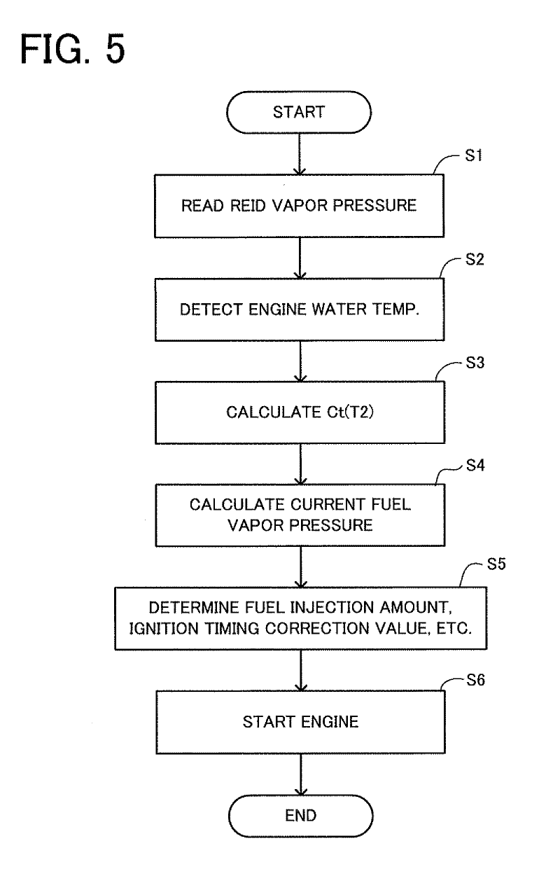

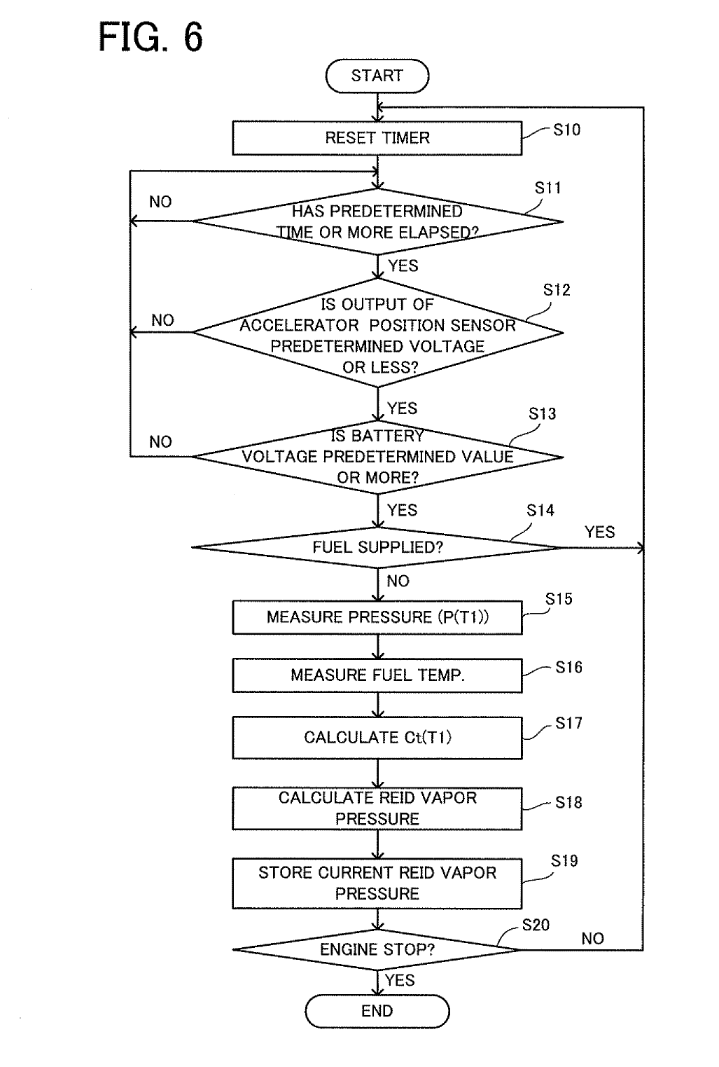

Next, operations of the fuel supply system 10 when operating under the above control concepts will be explained referring to FIGS. 5 and 6. FIG. 5 is a flowchart showing the details of the fuel supply control at the engine startup in the fuel supply system. FIG. 6 is a flowchart showing the details of a Reid vapor pressure measurement routine in the fuel supply system. The fuel supply control in the fuel supply system 10 is started when an ignition (IG) is turned ON.

When the ignition (IG) is turned ON, the ECU 30 reads a current Reid vapor pressure RVP stored in the RAM of the ECU 30 as shown in FIG. 5 (Step (also referred to as “S”) 1). This Reid vapor pressure RVP is an index that represents fuel volatility. A writing (storing) processing of the current Reid vapor pressure RVP to the RAM is conducted during execution of the Reid vapor pressure measurement routine (see FIG. 6) mentioned later.

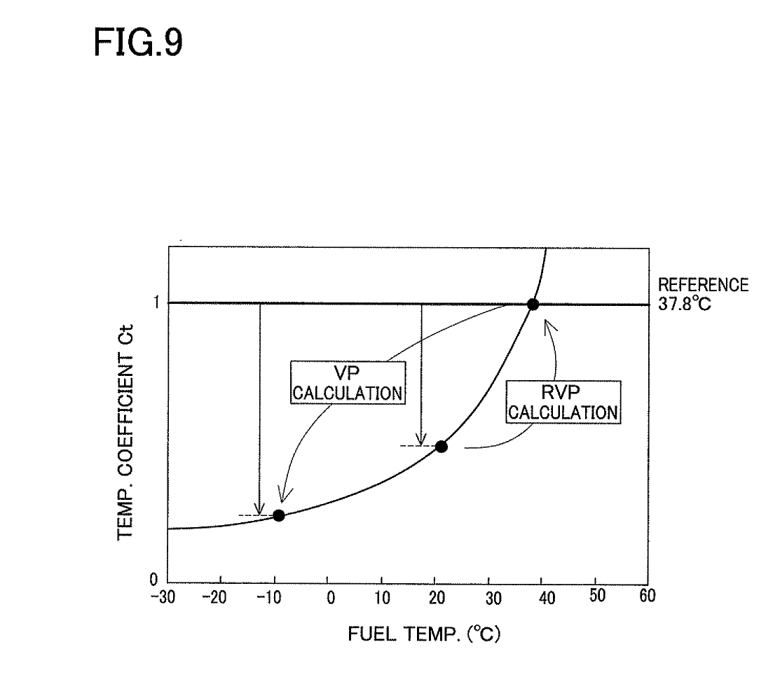

The ECU 30 detects the cooling water temperature of the engine 11 based on the signal from the water temperature 33 (Step 2). The ECU 30 calculates a temperature coefficient Ct(T2) based on the cooling water temperature detected in S2 (Step 3). Herein, the temperature coefficient Ct(T2) represents a change ratio of the vapor pressure changed according to the fuel temperature when the Reid vapor pressure RVP (37.8° C.) read in S1 is assumed to be 1 (see FIG. 9). The ECU 30 then calculates a current fuel vapor pressure VP by the following formula based on the Reid vapor pressure RVP (37.8° C.) read in S1 and the temperature coefficient Ct(T2) calculated in S3 (Step 4):

VP=RVP·Ct(T2)

Calculating the fuel vapor pressure from the temperature coefficient based on the cooling water temperature is to exactly calculate the vapor pressure in an injected state from the injector 12 (in the engine 11). In a cold region, for example, even if warm-up of the engine 11 is terminated, the fuel temperature sometimes remains low. In this case, when the fuel vapor pressure is calculated based on the fuel temperature, the fuel vapor pressure at the time of injection from the injector 12 cannot be calculated exactly. Calculating the fuel vapor pressure as above enables enhancement of control accuracy of the engine 11. An alternative is to determine the temperature used for calculating the fuel vapor pressure by selecting (switching) the cooling water temperature or the fuel temperature according to the operating state of the engine 11.

The ECU 30 then determines correction values of the fuel injection amount and the ignition timing and others at the startup based on the calculated fuel vapor pressure (Step 5). In the fuel supply system 10, accordingly, the fuel increasing amount correction and the ignition timing correction are executed based on the fuel vapor pressure at the startup. To be specific, the ECU 30 controls operations of the injector 12 and the igniter 36 to correct the fuel injection amount from the injector 12 and correct the ignition timing of the ignition plug 35. The ECU 30 performs the above fuel injection amount correction and ignition timing correction and then starts the engine 11 (Step 6).

In the fuel supply system 10, as above, the ECU 30 performs the fuel injection control at the startup time of the engine 11 based on the fuel vapor pressure. Accordingly, even when the fuel property (fuel type) changes, high-accurate fuel injection control can be performed. Consequently, since the fuel injection amount can be corrected to an optimum value required by the engine according to fuel type and fuel temperature, a stable combustion state is constantly achieved. In particular, HC reduction, startability, and driveability during non-operating time of the A/F sensor (during open control) during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

After the engine 11 is started, the ECU 30 executes the Reid vapor pressure measurement routine shown in FIG. 6. When this Reid vapor pressure measurement routine is started, as shown in FIG. 6, the ECU 30 resets a time (Step 10) and then determines whether or not the pressure measurement conditions for the pressure sensor 46 are satisfied (Step 11 to Step 14). In the present embodiment, the measurement conditions are defined as follows: A predetermined time has passed from the timer reset (Step 11); An output voltage of the accelerator position sensor 19 is a predetermined value or less, that is, the accelerator pedal 18 is not operated (Step 12); A battery voltage is a prescribed value (e.g., 6V) or higher (Step 13); and no fuel has been supplied (Step 14). The presence/absence of fuel supply in the present embodiment is determined based on a position signal of the float 29 but may be determined based on opening/closing of a fuel supply port.

If the above measurement conditions are satisfied (S11-S13: YES, S14: NO), that is, at idling or at deceleration where the fuel injection amount is low, the pressure of the vaporizing chamber 45 is measured in the fuel vapor generating section 40 (Step 15). To be concrete, the electromagnetic valve 41 is turned ON to open the nozzle 42. This allows the fuel to be injected from the nozzle 42 into the venturi 47. At that time, the venturi 47 is positioned to extend obliquely upward in the fuel vapor generating section 40 and the space volume of the venturi 47 is larger than the space volume of the vaporizing chamber 45, so that the fuel has collected in the inlet port (the throat part) of the venturi 47. The fuel collected in the venturi 47 becomes a resistance and the fuel injected from the nozzle 42 sticks to the wall surface of the inlet port of the venturi 47, thereby shielding the vaporizing chamber 45 from the outside. When the fuel injected from the nozzle 42 passes through the venturi 47 while the above state is maintained, the fuel in the vaporizing chamber 45 is pulled by the influence of viscosity. As soon as the fuel is injected from the nozzle 42, therefore, sufficient negative pressure is generated in the vaporizing chamber 45. As a result, the fuel is vaporized under reduced pressure, generating vapor pressure in the vaporizing chamber 45. At that time, the internal pressure of the vaporizing chamber 45 is detected by the pressure sensor 46 and the temperature T1 of fuel to be supplied to the fuel vapor generating section 40 is detected by the fuel temperature sensor 48 (Step 16).

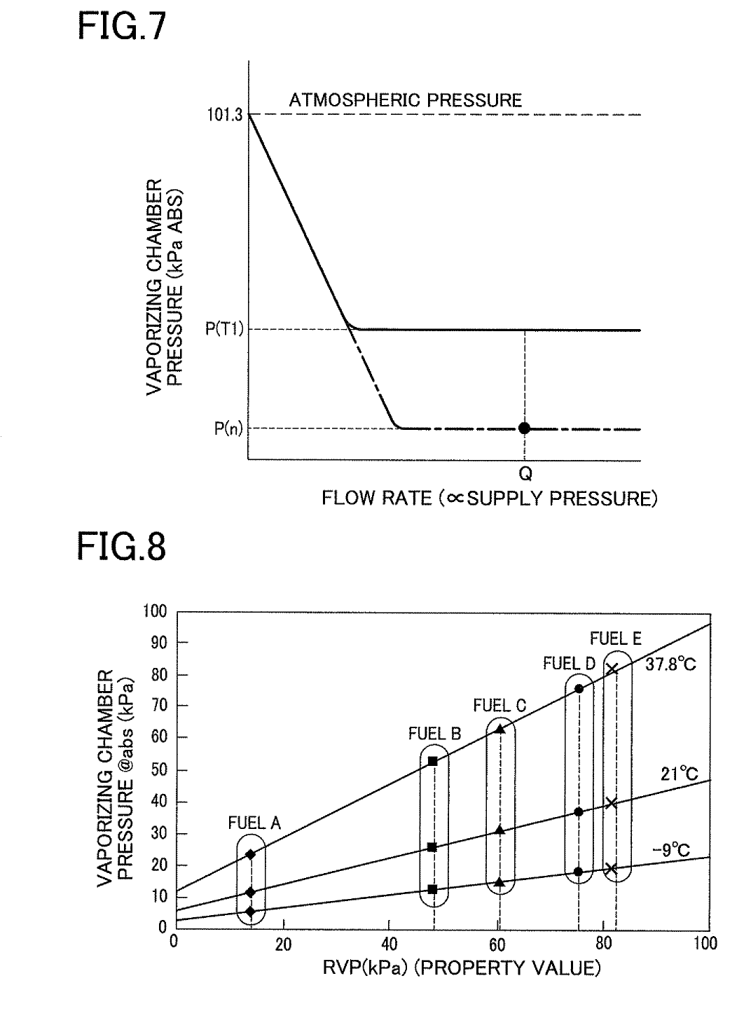

Herein, the pressure detected by the pressure sensor 46 is P(T1) shown in FIG. 7. This pressure P(T1) is a negative pressure (see a solid line) that has been recovered (reduced) by the vapor pressure generated when the fuel is vaporized under the reduced pressure than a negative pressure Pn (see an alternate short and long dash line) generated in the vaporizing chamber 45 when the fuel is injected from the nozzle 42 (at an injection flow rate Q (Q is constant)). FIG. 7 is a graph showing a relationship between an injection flow rate from the nozzle and the vaporizing chamber pressure (Feed pressure: 300 kPa).

On the other hand, in S11-13, if the pressure measurement conditions are not satisfied, the ECU 30 temporarily stops the subsequent steps until each condition is satisfied. If all the conditions are satisfied, the ECU 30 then determines whether or not fuel has been supplied (Step 14). If the fuel has been supplied (S14: YES), the ECU 30 resets the timer and repeats the determination of pressure measurement conditions (Step 11 to Step 14).

The ECU 30 calculates a temperature coefficient Ct(T1) based on the fuel temperature detected in S16 (Step 17). Subsequently, the ECU 30 calculates the Reid vapor pressure RVP (37.8° C.) by the following conversion formula based on the pressure P(T1) measured in S15 and the temperature coefficient Ct(T1) calculated in S17 (Step 18).

Herein, the conversion formula for calculating the Reid vapor pressure and the vapor pressure (volatility) at an arbitrary temperature is explained referring to FIGS. 8 and 9. FIG. 8 is a graph showing a relationship between the Reid vapor pressure (the material property) and the vaporizing chamber pressure. FIG. 9 is a graph showing a change ratio (temperature coefficient Ct) with respect to the temperature under the condition that the vaporizing chamber pressure at 37.8° C. determined from the result in FIG. 8 is set as a reference.

As is clear from FIG. 8, the vaporizing chamber pressure has a very high correlation with the Reid vapor pressure (the material property) at each fuel temperature regardless of the fuel type. With respect to the temperature change relative to the vaporizing chamber pressure at 37.8° C., the change ratio of the vaporizing chamber pressure changes at a certain ratio as shown in FIG. 9 regardless of the fuel type. Accordingly, as long as the pressure of the vaporizing chamber 45 and the fuel temperature can be detected, the Reid vapor pressure and the fuel vapor pressure (volatility) at an arbitrary temperature also can be easily calculated.

The conversion formula of the Reid vapor pressure RVP obtained from the above result is as follows:

RVP=1/Ct(T1)·A₀·P(T1)+B₀

where A₀ is a gradient of reference temperature (37.8° C.) and B₀ is a segment at reference temperature (37.8° C.).

Furthermore, the conversion formula of the vapor pressure VP at an arbitrary temperature is as follows:

VP(T2)=RVP·Ct(T2)

When the ECU 30 then calculates the Reid vapor pressure RVP (37.8° C.) as above, the calculated Reid vapor pressure RVP (37.8° C.) is overwritten as a current Reid vapor pressure RVP in the RAM. Thus, the previous Reid vapor pressure RVP is deleted and the current Reid vapor pressure RVP is stored (Step 19). When the engine 11 is stopped, this processing routine is terminated (Step 20). The current Reid vapor pressure RVP stored as above is read at the time of next engine startup (see Step 1).

In the fuel supply system 10 in the present embodiment as explained in detail above, the fuel vapor generating section 40 is configured such that the fuel is vaporized under reduced pressure to generate vapor pressure, the pressure sensor 46 detects the pressure of the vaporizing chamber 45 at the time, and the ECU 30 calculates and stores the Reid vapor pressure RVP (37.8° C.) from the temperature coefficient Ct(T1) based on a detection signal from the fuel temperature sensor 48. At startup of the engine 11, the current fuel vapor pressure VP is calculated based on that Reid vapor pressure RVP (37.8° C.) and the temperature coefficient Ct(T2) calculated based on the detection signal from the water temperature sensor 33, and the fuel amount increasing control at the startup time of the engine 11 is executed by use of that fuel vapor pressure VP. Therefore, the fuel injection amount can be corrected to an optimum value required by the engine 11 according to fuel types and temperatures. Consequently, a stable combustion state is constantly achieved. In particular, I-IC reduction, startability, and driveability during non-operating time of the A/F sensor (during open control) during a cold period can be enhanced. Furthermore, vapor pressure (fuel property) according to destination place can be detected. Thus, adaptation of the internal combustion engines to the types of fuel is not required. This can achieve easy model development and largely reduce man-hour requirements.

In the fuel supply system 10, furthermore, the fuel vapor generating section 40 is placed in the fuel tank 20 to avoid any influence from ambient temperature, enabling measurement of stable fuel vapor pressure. In addition, since the fuel temperature sensor 46 is immersed in liquid, the fuel vapor generating section 40 is not influenced by ambient temperature. The fuel vapor pressure can therefore be calculated with higher accuracy.

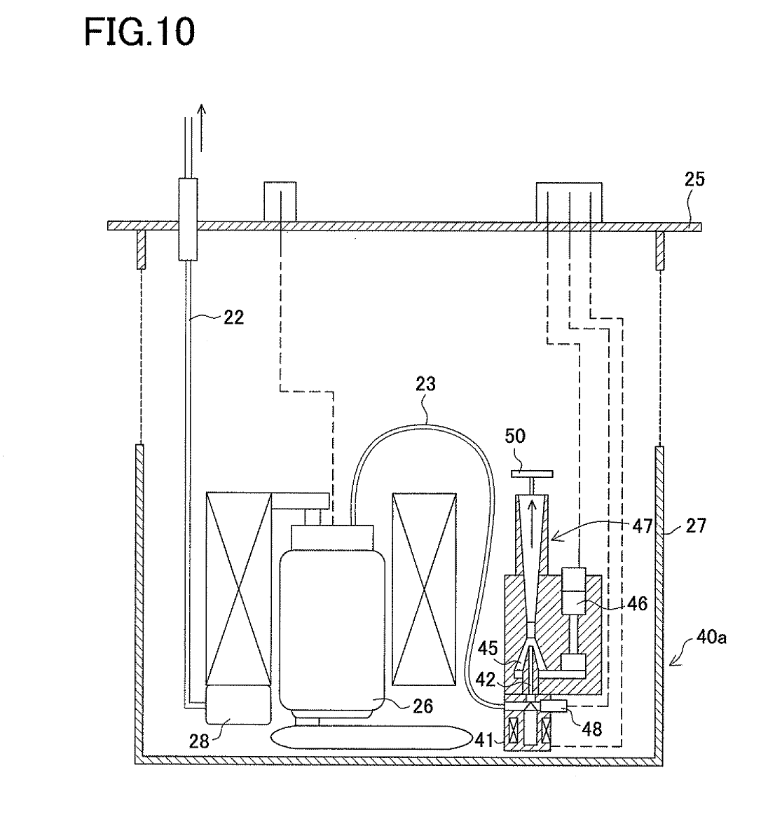

Herein, to enhance the measurement accuracy of the fuel vapor pressure, the fuel temperature needs to be exactly detected without variations. Instead of mounting the fuel vapor generating section on the set plate 25, a fuel vapor generating section 40a may be placed at the bottom of the reserve cup 27 so that the fuel temperature sensor 48 is located at the bottom of the reserve cup 27 as shown in FIG. 10. With such configuration, the fuel can exist stably at the bottom of the reserve cup 27 and hence the fuel temperature is stable. Accordingly, the fuel temperature sensor 48 can be immersed reliably and thus the fuel temperature can be detected exactly without variations. This can further enhance the measurement accuracy of the fuel vapor pressure.

In the fuel supply system 10 in the present embodiment, the fuel vapor generating section 40 is configured such that the venturi 47 is positioned to extend obliquely upward and the space volume of the venturi 47 is larger than the space volume of the vaporizing chamber 45. The fuel can therefore be reliably collected in the inlet port of the venturi 47. This makes it possible to immediately generate negative pressure in the vaporizing chamber 45 as soon as the fuel is injected from the nozzle 42, vaporizing the fuel under reduced pressure to generate vapor pressure, and detect the pressure of the vaporizing chamber 45 at the time by the pressure sensor 46. The ECU 30 can calculate the Reid vapor pressure RVP (37.8° C.) from on the temperature coefficient Ct(T1) based on the detection signal from the fuel temperature sensor 48 without loss of responsivity.

Herein, a modified example of the fuel vapor generating section is explained. The fuel vapor generating section explained below is attached to the reserve cup or the set plate and placed in the fuel tank. As a first modified example, as shown in FIG. 10, a fuel vapor generating section 40a is placed at the bottom of the reserve cup 27 and a reflection plate 50 is provided near, an outlet port of a venturi 47. This configuration allows the fuel to collide with the reflection plate 50 and return into the venturi 47, so that the fuel can be more reliably collected in the venturi 47. As a result, the fuel injected from the nozzle 42 immediately sticks to the wall surface of the inlet port of the venturi 47, thereby shielding the vaporizing chamber 45 from the outside. A sufficient negative pressure can be instantly created in the vaporizing chamber 45.

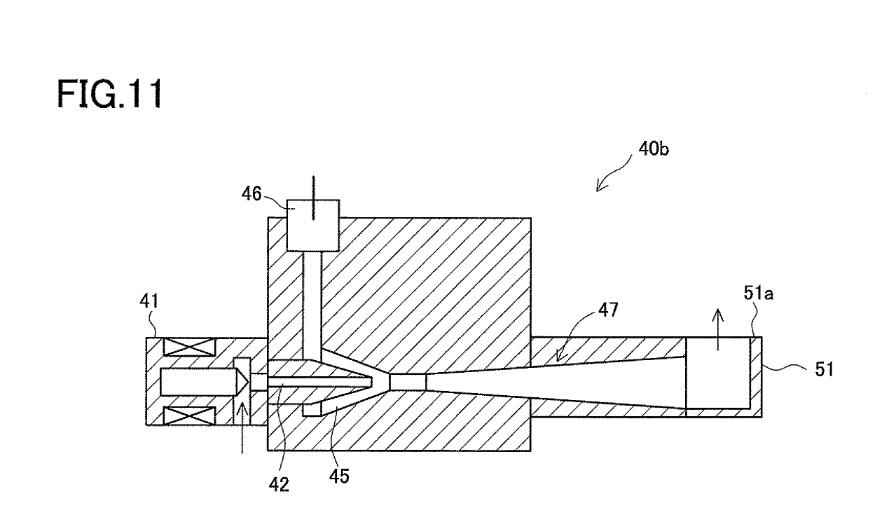

As a second modified example, as shown in FIG. 11, a fuel vapor generating section 40h is configured such that an end plate 51 is provided at an outlet port of the venturi 47. With this configuration, a flow of the fuel flowing out of the venturi 47 is interrupted by the end plate 51 and thus the fuel can be collected in the venturi 47. In this case, the end plate 51 has to be provided so that the inlet port of the venturi 47 is located below an uppermost position 51a of the end plate 51 in a gravity direction. This configuration can enhance the effect of the end plate 51 and reliably collect the fuel in the venturi 47. Also in the second modified example, the fuel can be reliably collected in the venturi 47, so that the fuel injected from the nozzle 42 immediately sticks to the wall surface of the inlet port of the venturi 47, thereby shielding the vaporizing chamber 45 from the outside. A sufficient negative pressure can therefore be instantly created in the vaporizing chamber 45.

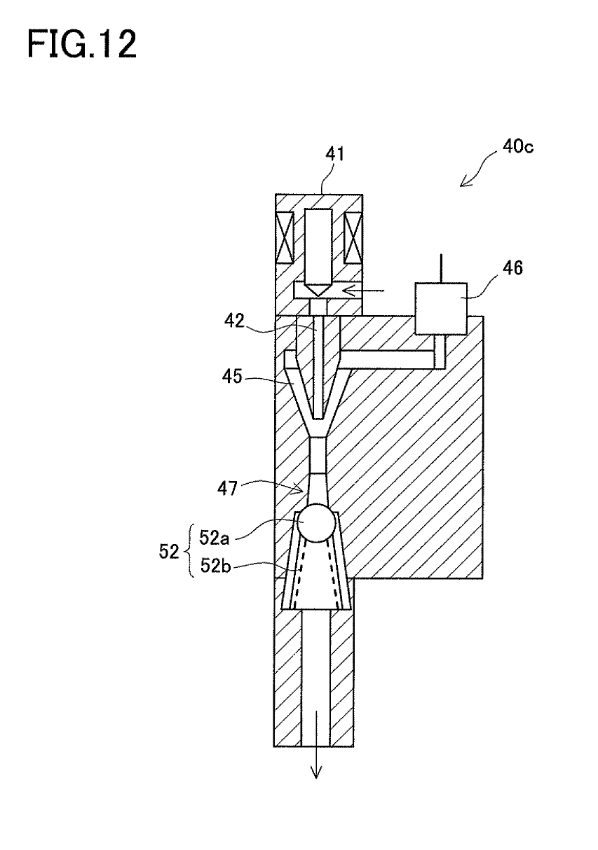

As a third modified example, as shown in FIG. 12, a fuel vapor generating section 40c is configured such that a check valve 52 is provided in the venturi 47 to prevent a flow of fuel from the outlet port to the inlet port of the venturi 47. The check valve 52 is constituted of a ball valve element 52a and a spring 52b for urging the ball valve element 52a toward the inlet port side of the venturi 47. Accordingly, while the fuel is being injected from the nozzle 42, the ball valve element 52a is moved to the outlet port side of the venturi to allow the fuel to be discharged from the venturi 47. On the other hand, when the fuel injection from the nozzle 42 is stopped, the venturi 47 is blocked off by the check valve 52. Thus, when the fuel is injected from the nozzle 42 next time, the fuel is immediately collected in the vicinity of the inlet port of the venturi 47 and sticks to the wall surface of the venturi 47, thereby shielding the vaporizing chamber 45 from the outside. Therefore, sufficient negative pressure can be instantly generated in the vaporizing chamber 45.

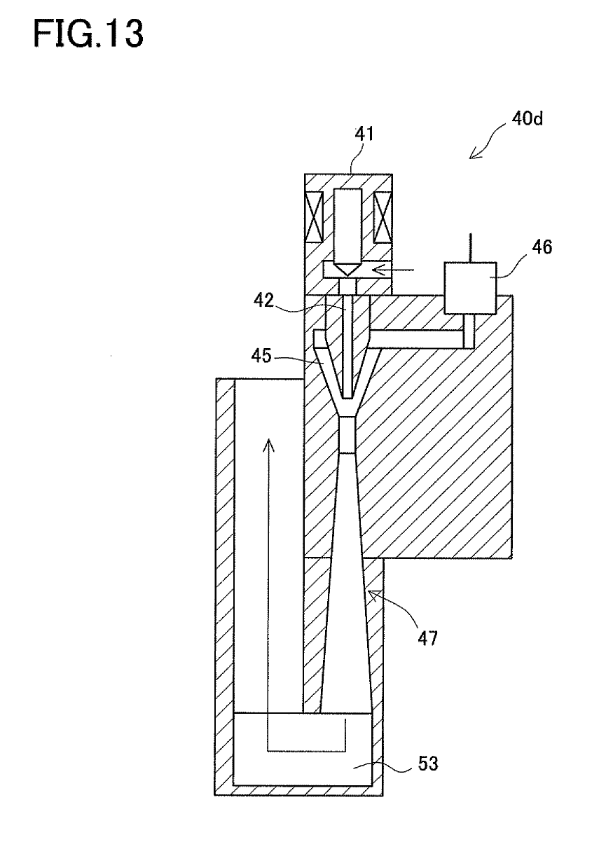

As a fourth modified example, as shown in FIG. 13, a fuel vapor generating section 40d is configured such that the outlet port of the venturi 47 is located in a lower position (facing downward) than the inlet port in a gravity direction and a fuel reservoir 53 is provided in the outlet port of the venturi 47. This fuel reservoir 53 allows the venturi 47 to be filled with the fuel as soon as the fuel is injected from the nozzle 42 even if the venturi 47 is placed to extend downward. Accordingly, the fuel injected from the nozzle 42 sticks to the wall surface of the inlet port of the venturi 47, thereby shielding the vaporizing chamber 45 from the outside, thus enabling instant generation of sufficient negative pressure in the vaporizing chamber 45.

In the above first to fourth modified examples, the fuel injected from the nozzle 42 immediately sticks to the wall surface of the inlet port of the venturi 47, thereby shielding the vaporizing chamber 45 from the outside, thus instantly generating sufficient negative pressure in the vaporizing chamber 45. Accordingly, the Reid vapor pressure RVP (37.8° C.) can be accurately calculated without loss of responsivity.

In the fuel supply system 10 in the present embodiment, when the fuel vapor pressure VP is to be measured, the current fuel vapor pressure VP is calculated based on the stored Reid vapor pressure RVP and the detection signal from the water temperature sensor 33. Therefore, there is no need to constantly detect the pressure and the fuel temperature of the vaporizing chamber 45. This can prevent deterioration of the pressure sensor 46 and the fuel temperature sensor 48 and reduce power consumption. The fuel vapor pressure VP can thus be stably accurately measured and a decrease in fuel efficiency can be prevented.

The Reid vapor pressure stored in the RAM of the ECU 30 is updated every time (at regular intervals) the engine 11 is started. Even when the fuel property changes with time, the fuel vapor pressure VP can be stably accurately measured.

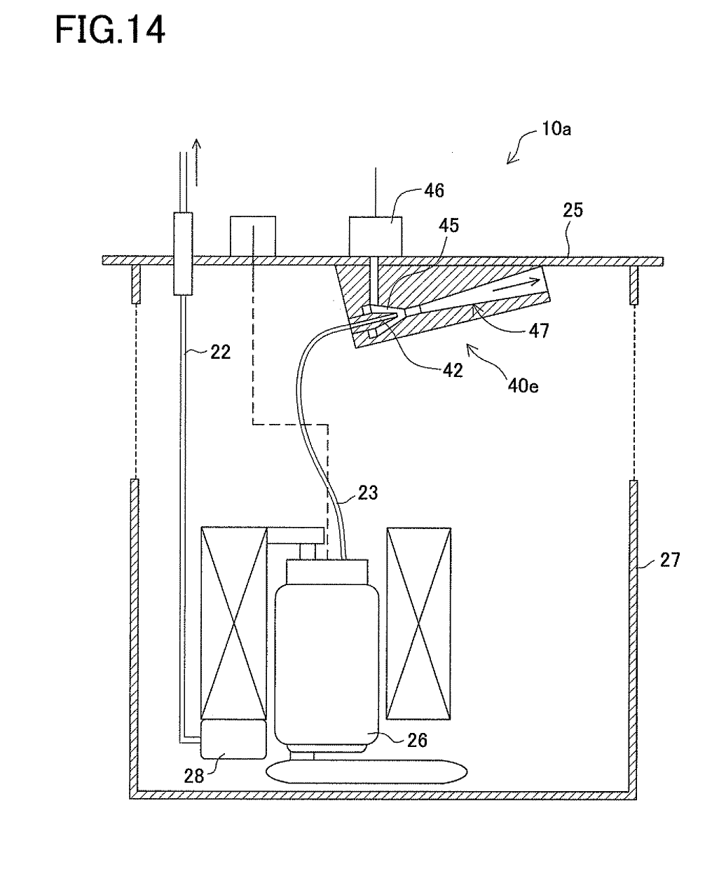

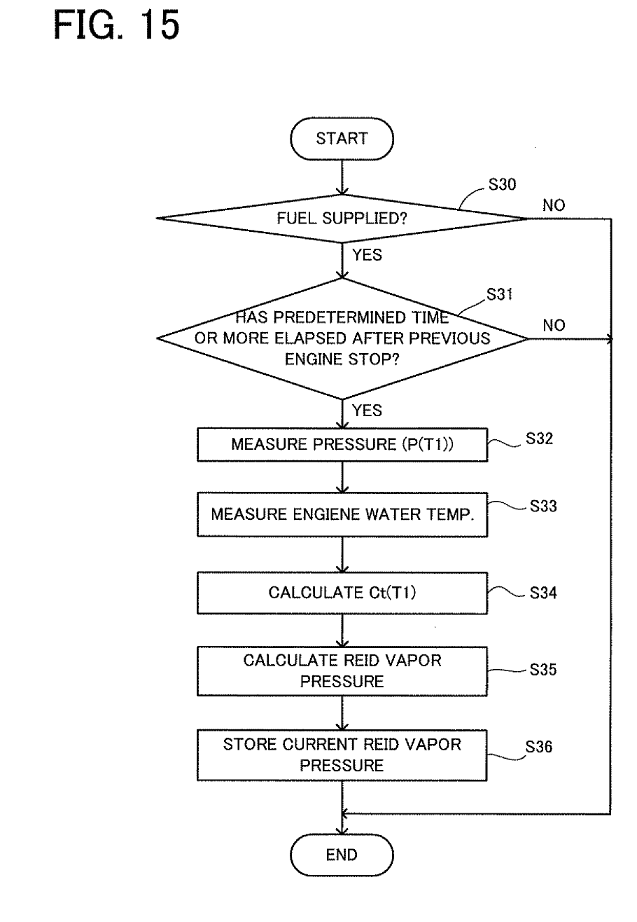

A second embodiment will be explained below. The second embodiment is substantially identical in configuration to the first embodiment excepting that a fuel vapor generating section is not provided with an electromagnetic valve and a fuel temperature sensor. The following explanation is thus made on a fuel supply system of the second embodiment referring to FIGS. 14 and 15 with a focus on differences from the first embodiment while identical parts or components to those in the first embodiment are given the same reference signs and their explanations are appropriately omitted. FIG. 14 is a schematic configuration view of a main part of a fuel supply system of the second embodiment. FIG. 15 is a flowchart showing the details of a Reid vapor pressure measurement routine in the fuel supply system.

As shown in FIG. 14, a fuel vapor generating section 40b in a fuel supply system 10a of the second embodiment includes a nozzle 42, a vaporizing chamber 45, a pressure sensor 46, and a venturi 47. That is, the fuel vapor generating section 40b does not include an electromagnetic valve and a fuel temperature sensor. Such fuel vapor generating section 40b is mounted on the set plate 25 as with the first embodiment. To be concrete, there are provided a first fuel path 22 for supplying fuel from the fuel pump 26 to the injector 12 and a second fuel path 23 for supplying fuel from the fuel pump 26 to the fuel vapor generating section 40b. The other end of the second fuel path 23 is connected to an inlet port of the fuel vapor generating section 40b. Thus, when the fuel is supplied at a constant pressure from the fuel pump 26 to the fuel vapor generating section 40b the fuel is injected from the nozzle 42 toward the venturi 47. At that time, as with the first embodiment, the fuel is boiled under reduced pressure by the negative pressure generated in the vaporizing chamber 45 and the internal pressure of the vaporizing chamber 45 at the time when the vapor pressure is generated is detected by the pressure sensor 46.

The following explanation is given to the Reid vapor pressure measurement in the fuel supply system 10a, referring to FIG. 15. In the fuel supply system 10a, similarly, when the engine 11 is started, the ECU 30 executes the Reid vapor pressure measurement routine. When this Reid vapor pressure measurement routine is executed, as shown in FIG. 15, the ECU 30 determines whether or not the pressure measurement conditions (Steps 30 and 31) are satisfied. These measurement conditions in the present embodiment are defined, differently from those in the first embodiment, as follows: Fuel has been supplied (Step 30); and A prescribed time or more has passed after the previous engine stop (Step 31). The prescribed time in S31 is set to a time needed until the fuel temperature and the cooling water temperature of the engine 11 become equal.

When the above pressure measurement conditions are satisfied, the ECU 30 detects a pressure (P(T)) of the vaporizing chamber 45 based on a signal from the pressure sensor 46 (Step 32), and detects the cooling water temperature of the engine 11 based on a signal from the water temperature sensor 33 (Step 33). The ECU 30 then calculates a temperature coefficient Ct(T) based on the cooling water temperature detected in S33 (Step 34). Subsequently, the ECU 30 calculates a Reid vapor pressure RVP (37.8° C.) by the aforementioned conversion formula based on the pressure P(T) detected in S32 and the temperature coefficient Ct(T) calculated in S34 (Step 35). The ECU 30 then overwrites the calculated Reid vapor pressure RVP (37.8° C.) as a current Reid vapor pressure RVP in the RAM. Accordingly, the previous Reid vapor pressure RVP is deleted and the current Reid vapor pressure RVP is stored (Step 36). In other words, the Reid vapor pressure RVP is updated at the time when fuel is replenished.

At the next startup time of the engine 11, the ECU 30 reads the current Reid vapor pressure RVP stored in S36 and calculates a fuel vapor pressure VP based on a temperature coefficient (Ct(T2)) calculated based on the cooling water temperature of the engine 11 measured at the time. The injection amount is corrected based on this vapor pressure VP and the engine 11 is started (see FIG. 5).

Also in the fuel supply system 10a of the second embodiment, as above, the same fuel injection control as in the first embodiment is performed by the ECU 30 and the same effects as in the first embodiment can be provided. The fuel supply system 10a includes neither an electromagnetic valve nor a fuel temperature sensor and hence can achieve more cost reduction and more size reduction.

Since the Reid vapor pressure is updated when fuel is replenished, the fuel vapor pressure VP can be measured accurately even when the fuel property changes due to the fuel replenishment.

### Third Embodiment

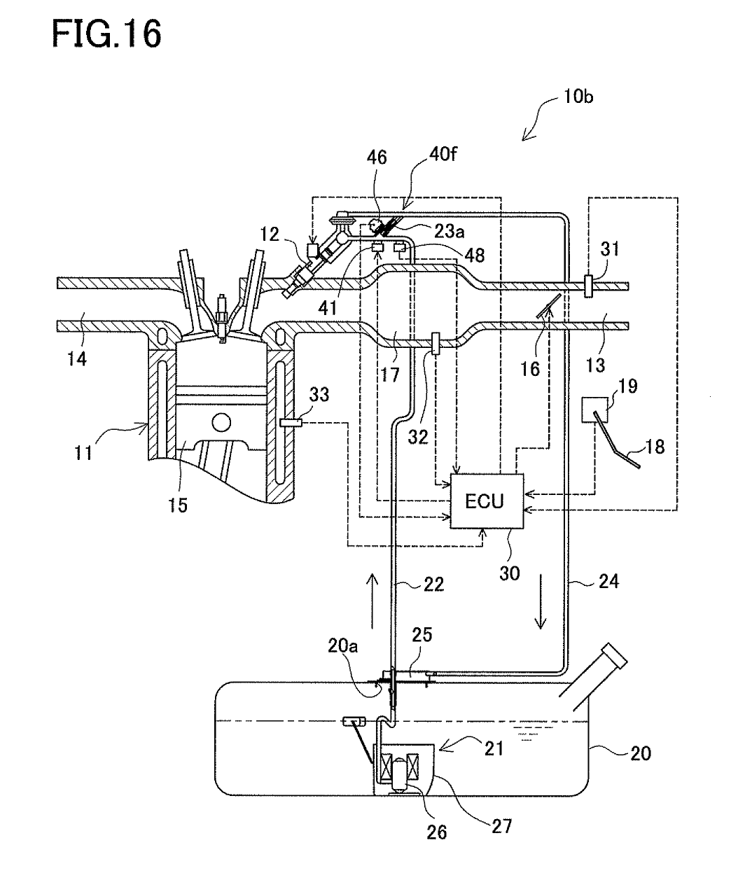

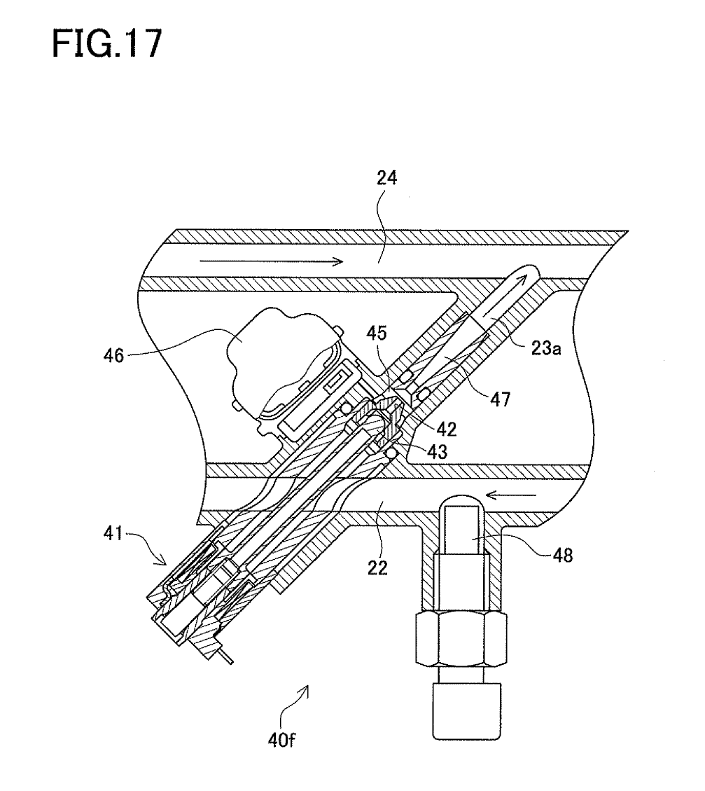

A third embodiment will be last explained. In the third embodiment, a fuel vapor generating section is placed outside of the fuel tank. To be concrete, in the third embodiment, a return fuel path is provided and the fuel vapor generating section is provided with a bypass fuel path (corresponding to the second fuel path) for providing communication between the first fuel path and the return fuel path. It is to be noted that the configuration of the fuel vapor generating section is basically identical to that in the first embodiment. The following explanation is made on a fuel supply system of the third embodiment with a focus on differences from the first embodiment referring to FIGS. 16 and 17 while the common parts or components with those in the first embodiment are given the same reference signs and their details are appropriately omitted. FIG. 16 is a schematic configuration view of the fuel supply system of the third embodiment and FIG. 17 is a partial cross sectional view showing a schematic configuration of a fuel vapor generating section.

As shown in FIG. 16, a fuel supply system 10b of the third embodiment is configured such that, surplus fuel of the fuel supplied from a fuel pump 26 to an injector 12 through a first fuel path 22 is returned to a fuel tank 20 through a return fuel path 24. A bypass fuel path 23a for allowing communication between the first fuel path 22 and the return fuel path 24 is placed near the injector 12. A fuel vapor generating section 40f is thus placed here. This fuel vapor generating section 40f includes, as shown in FIG. 17, an electromagnetic valve 41, a vaporizing chamber 45, a pressure sensor 46, a venturi 47, and a fuel temperature sensor 48. To be concrete, the electromagnetic valve 41 and the venturi 47 are provided in the bypass fuel path 23a. A nozzle 42 is provided at the end of the electromagnetic valve 41. The nozzle 42 is opened and closed by a valve element 43. When this electromagnetic valve 41 is turned ON and fuel is supplied at a constant pressure to the fuel vapor generating section 40f, the fuel is injected from the nozzle 42 toward the venturi 47. At that time, as with the first embodiment, the fuel is boiled under reduced pressure by negative pressure generated vaporizing chamber 45 and the internal pressure of the vaporizing chamber 45 caused when the vapor pressure occurs is detected by the pressure sensor 46.

Also in the fuel supply system 10b of the third embodiment, as above, the same fuel injection control as in the first embodiment is performed by the ECU 30 and the same effects as in the first embodiment can be provided. In the fuel supply system 10b, furthermore, the fuel vapor pressure can be measured in the vicinity of the injector 12 for injecting and supplying the fuel to the engine 11. Accordingly, since the fuel injection amount can be corrected to an optimum value required by the engine 11 according to fuel types and temperatures, a stable combustion state can be achieved at the startup of the engine 11. In particular, HC reduction, startability, and driveability during non-operating time of the A/F sensor (during open control) during a cold period can be enhanced.

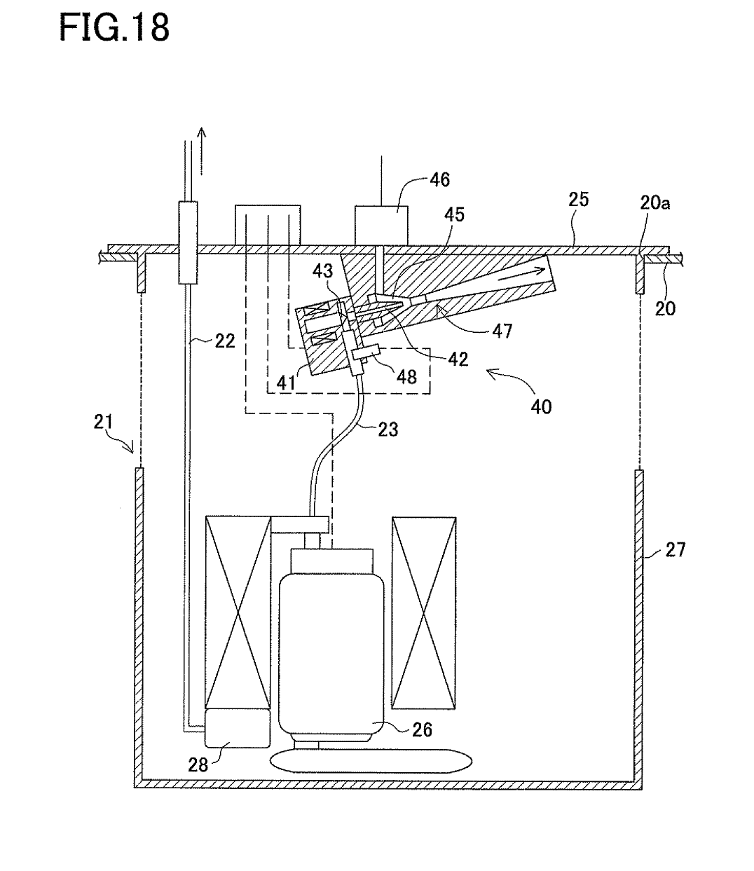

It should be understood that the aforementioned embodiments are mere examples and the present invention is not limited thereto and the present invention may be embodied in other specific forms without departing from the essential characteristics thereof. For instance, In the first or second embodiment, one end of the second fuel path 23 is connected to the fuel pump 26. As an alternative, one end of the second fuel path 23 is connected to (branched off from) the first fuel path 22 as shown in FIG. 18.

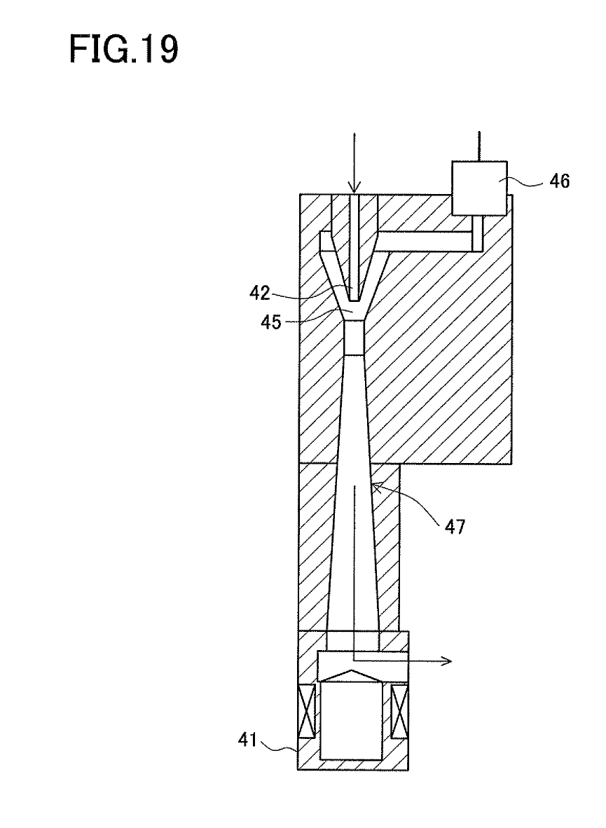

In the above first or third embodiment, the electromagnetic valve 41 for controlling the inflow of fuel into the vaporizing chamber 45 is placed upstream of the vaporizing chamber 45. As an alternative, it is placed downstream of the vaporizing chamber 45 as shown in FIG. 19. Accordingly, even when the venturi 47 is positioned to extend downward as shown in FIG. 19, the fuel remains filled in the venturi 47 while the electromagnetic valve 41 is kept ON. When the fuel is injected from the nozzle 42, the fuel immediately sticks to the wall surface of the inlet port of the venturi 47, thereby shielding the vaporizing chamber 45 from the outside. Consequently, sufficient negative pressure can be instantly generated in the vaporizing chamber 45.

In the above embodiments, the pressure regulator 28 is placed in the first fuel path 22. The pressure regulator 28 also can be placed in the fuel pump 26 or the second fuel path 23.

In the above embodiments, because of simplification of arithmetic processing and storage, the ECU 30 stores the Reid vapor pressure RVP to calculate the fuel vapor pressure. Instead of the Reid vapor pressure, two parameters, i.e., the vaporizing chamber pressure detected by the pressure sensor 46 and the fuel temperature detected by the fuel temperature sensor 48 at the time, may be stored directly so that the fuel vapor pressure can be calculated by using those two parameters. Another alternative is to store, as a typical value, a vapor pressure at a specific temperature, the vapor pressure being calculated from two parameters, i.e., the vaporizing chamber pressure detected by the pressure sensor 46 and the fuel temperature detected by the fuel temperature sensor 48 at the time, instead of the Reid vapor pressure, and calculate a fuel vapor pressure by using the vapor pressure at the specific temperature.

1. A fuel vapor pressure measuring device comprising:
a fuel tank for storing fuel;
a fuel pump for supplying the fuel in the fuel tank to a fuel injection device;
a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber;
a first fuel path that connects the fuel pump and the fuel injection device;
a second fuel path having one end connected to the fuel pump or the first fuel path and the other end connected to the fuel vapor generating section;
pressure detection means for detecting pressure of the fuel vapor generating section; and
vapor pressure calculation means for calculating fuel vapor pressure based on a detection result of the pressure detection means,
the fuel vapor generating section being placed in the fuel tank.

2. The fuel vapor pressure measuring device according to claim 1 further comprising pressure regulation means is placed in the first fuel path, the second fuel path, or the fuel pump and configured to regulate a pressure of fuel allowed to flow in the fuel vapor generating section at a constant pressure.

3. The fuel vapor pressure measuring device according to claim 1 further comprising:
fuel temperature detection means for detecting a temperature of fuel allowed to pass through the fuel vapor generating section,
wherein the vapor pressure calculation means is configured to correct the fuel vapor pressure calculated based on the detection result of the pressure detection means so that the fuel vapor pressure is corrected based on a detection result of the fuel temperature detection means.

4. The fuel vapor pressure measuring device according to claim 1 further comprising: a control valve placed upstream of an inlet port of the vaporizing chamber or downstream of an outlet port of the vaporizing chamber, the control valve being configured to control inflow of the fuel to the vaporizing chamber.

5. The fuel vapor pressure measuring device according to claim 1, wherein the fuel vapor generating section is housed together with the fuel pump in a sub-tank of the fuel tank.

6. The fuel vapor pressure measuring device according to claim 5, wherein the fuel pump is placed in the sub-tank to return the fuel that flows out of the fuel vapor generating section to the sub-tank.

7. The fuel vapor pressure measuring device according to claim 3, wherein the fuel temperature detection means is placed upstream of and near the nozzle.

8. The fuel vapor pressure measuring device according to claim 3, wherein the fuel temperature detection means is integrally attached to the fuel vapor generating section.

9. The fuel vapor pressure measuring device according to claim 8, wherein
the fuel pump is attached to a fuel supply device including a sub-tank, and
the fuel temperature detection means is placed near a bottom of the sub-tank.

10. The fuel vapor pressure measuring device according to claim 1, wherein the pressure detection means is placed outside of the fuel tank.

11. The fuel vapor pressure measuring device according to claim 10, wherein
the fuel vapor generating section is placed near a cover member of the fuel tank, and
the pressure detection means is placed on the cover member outside of the fuel tank.

12. The fuel vapor pressure measuring device according to claim 10, wherein the pressure detection means and the fuel vapor generating section are connected to each other through a pressure sensitive wall.

13. A fuel vapor pressure measuring device comprising:
a fuel tank for storing fuel;
a fuel pump for supplying the fuel in the fuel tank to a fuel injection device;
a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber;
a first fuel path that connects the fuel pump and the fuel injection device;
a second fuel path having one end connected to the fuel pump or the first fuel path and the other end connected to the fuel vapor generating section;
pressure detection means for detecting pressure of the fuel vapor generating section; and
vapor pressure calculation means for calculating fuel vapor pressure based on a detection result of the pressure detection means,
the fuel vapor generating section is configured to allow fuel injected in the venturi to be collected in the venturi.

14. The fuel vapor pressure measuring device according to claim 13, wherein the fuel vapor generating section is configured such that an inlet port of the venturi is positioned below an outlet port of the venturi in a gravity direction.

15. The fuel vapor pressure measuring device according to claim 13, wherein the fuel vapor generating section includes a reflection plate for returning the fuel that flows out of the venturi to the venturi, the reflection plate being located near the outlet port of the venturi.

16. The fuel vapor pressure measuring device according to claim 14, wherein a volume of the venturi is larger than a volume of the vaporizing chamber.

17. The fuel vapor pressure measuring device according to claim 13, wherein the fuel vapor generating section includes an end plate for interrupting a flow of fuel flowing out of the venturi, the end plate being located near the outlet port of the venturi.

18. The fuel vapor pressure measuring device according to claim 17, wherein an inlet port of the venturi is located below an uppermost position of the end plate in a gravity direction.

19. The fuel vapor pressure measuring device according to claim 13, wherein the fuel vapor generating section includes a check valve for preventing a fuel flow from the outlet port to the inlet port of the venturi, the check valve being placed in the venturi.

20. The fuel vapor pressure measuring device according to claim 13, wherein the fuel vapor generating section is configured such that the outlet port of the venturi is located below the inlet port of the venturi in a gravity direction and a fuel reservoir is provided in the outlet port of the venturi.

21. A fuel vapor pressure measuring device comprising:
a fuel tank for storing fuel to be supplied to an internal combustion engine;
a fuel pump for supplying the fuel in the fuel tank to a fuel injection device;
a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber;
a first fuel path that connects the fuel pump and the fuel injection device;
a second fuel path having one end connected to the fuel pump or the first fuel path and the other end connected to the fuel vapor generating section;
pressure detection means for detecting pressure of the fuel vapor generating section; and
fuel temperature detection means for detecting a temperature of fuel allowed to pass through the fuel vapor generating section;
characteristic storage means for storing fuel vapor characteristic obtained based on a detection result of the pressure detection means and a detection result of the fuel detection means;
vapor pressure calculation means for calculating fuel vapor pressure based on the fuel vapor characteristic stored in the characteristic storage means and the fuel temperature detected by the fuel temperature detection means.

22. A fuel vapor pressure measuring device comprising:
a fuel tank for storing fuel to be supplied to an internal combustion engine;
a fuel pump for supplying the fuel in the fuel tank to a fuel injection device;
a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber;
a first fuel path that connects the fuel pump and the fuel injection device;
a second fuel path having one end connected to the fuel pump or the first fuel path and the other end connected to the fuel vapor generating section;
pressure detection means for detecting pressure of the fuel vapor generating section;
fuel temperature detection means for detecting a temperature of fuel allowed to pass through the fuel vapor generating section;
coolant temperature detection means for detecting a temperature of coolant to cool the internal combustion engine;
characteristic storage means for storing fuel vapor characteristic obtained based on a detection result of the pressure detection means and a detection result of the fuel detection means;
vapor pressure calculation means for calculating fuel vapor pressure based on the fuel vapor characteristic stored in the characteristic storage means and a coolant temperature detected by the coolant temperature detection means.

23. A fuel vapor pressure measuring device comprising:
a fuel tank for storing fuel to be supplied to an internal combustion engine;
a fuel pump for supplying the fuel in the fuel tank to a fuel injection device;
coolant temperature detection means for detecting a temperature of coolant to cool the internal combustion engine;
a fuel vapor generating section including a nozzle, a vaporizing chamber, and a venturi, the fuel vapor generating section being configured to inject the fuel from the nozzle to pass through the venturi, thereby vaporizing the fuel in the vaporizing chamber;
a first fuel path that connects the fuel pump and the fuel injection device;
a second fuel path having one end connected to the fuel pump or the first fuel path and the other end connected to the fuel vapor generating section;
pressure detection means for detecting pressure of the fuel vapor generating section;
fuel temperature detection means for detecting a temperature of fuel allowed to pass through the fuel vapor generating section;
characteristic storage means for storing fuel vapor characteristic obtained based on a detection result of the pressure detection means and a detection result of the coolant temperature detection means;
vapor pressure calculation means for calculating fuel vapor pressure based on the fuel vapor characteristic stored in the characteristic storage means and a coolant temperature detected by the coolant temperature detection means.

24. The fuel vapor pressure measuring device according to claim 21, wherein the characteristic storage means stores Reid vapor pressure as the fuel vapor characteristic.

25. The fuel vapor pressure measuring device according to claim 21, wherein
the characteristic storage means updates the fuel vapor characteristic at a constant time interval,
the vapor pressure calculation means calculates the fuel vapor pressure based on the updated fuel vapor characteristic and the temperature detected by the fuel temperature detection means or the coolant temperature detection means.

26. The fuel vapor pressure measuring device according to claim 25, wherein the characteristic storage means updates the fuel vapor characteristic every time the internal combustion engine is started.

27. The fuel vapor pressure measuring device according to claim 25, wherein the characteristic storage means updates the fuel vapor characteristic when the fuel tank is replenished with fuel.

28. The fuel vapor pressure measuring device according to claim 21, wherein the characteristic storage means stores the fuel vapor characteristic under an operating condition of the internal combustion engine that an injection amount from the fuel injection device decreases.

29. The fuel vapor pressure measuring device according to claim 21 further comprising a control valve for controlling inflow of fuel into the nozzle, the control valve being placed upstream or downstream of the nozzle,
wherein the control valve is opened when the fuel vapor characteristic stored in the characteristic storage means is to be obtained.

30. The fuel vapor pressure measuring device according to claim 21 further comprising operation control means for controlling an operating state of the internal combustion engine,
wherein the operation control means corrects a fuel injection amount in the fuel injection device based on a fuel vapor pressure calculated by the vapor pressure calculation means.

31. The fuel vapor pressure measuring device according to claim 21 further comprising operation control means for controlling an operating state of the internal combustion engine,
wherein the operation control means corrects an ignition timing of the internal combustion engine based on the fuel vapor pressure calculated by the vapor pressure calculation means.
